(19) United States
(12) Patent Application Publication
(10) Pub. No.: US 2021/0148810 A1
(43) Pub. Date: May 20, 2021

(54) METHODS FOR DETERMINING PARTICLE SIZE AND LIGHT DETECTION SYSTEMS FOR SAME

(71) Applicant: BECTON, DICKINSON AND COMPANY, Franklin Lakes, NJ (US)

(72) Inventors: Ihor V. Berezhnyy, Los Gatos, CA (US); Svitlana Berezhna, Los Gatos, CA (US)

(21) Appl. No.: 17/078,932

(22) Filed: Oct. 23, 2020

Related U.S. Application Data
(60) Provisional application No. 62/936,121, filed on Nov. 15, 2019.

(51) Int. Cl. G01N 15/14

(52) U.S. Cl. CPC G01N 15/1436; G01N 2015/1493

(57) ABSTRACT

Methods for determining a size of a particle in a flow stream from scattered light are described. Methods according to certain embodiments include detecting scattered light from a flow stream with two or more photodetectors, generating a data signal from the scattered light with each of the photodetectors, calculating a ratio of data signals from two or more of the photodetectors and determining the size of the particle based on the calculated ratio of the data signals. Light detection systems having two or more photodetectors for detecting scattered light from a flow stream are also provided. Integrated circuits (e.g., field programmable gate arrays) programmed to determine the size of a particle from scattered light data signals are also provided.

### CROSS-REFERENCE TO RELATED APPLICATION

This application is related to U.S. Provisional Patent Application Ser. No. 62/936,121 filed Nov. 15, 2019; the disclosure of which application is herein incorporated by reference.

### INTRODUCTION

Light detection is often used to characterize components of a sample (e.g., biological samples), for example when the sample is used in the diagnosis of a disease or medical condition. When a sample is irradiated, light can be scattered by the sample, transmitted through the sample as well as emitted by the sample (e.g., by fluorescence). Variations in the sample components, such as morphologies, absorptivity and the presence of fluorescent labels may cause variations in the light that is scattered, transmitted or emitted by the sample. To quantify these variations, the light is collected and directed to the surface of a detector.

One technique that utilizes light detection to characterize the components in a sample is flow cytometry. Using data generated from the detected light, properties of the components can be recorded and where desired material may be sorted. A flow cytometer typically includes a sample reservoir for receiving a fluid sample, such as a blood sample, and a sheath reservoir containing a sheath fluid. The flow cytometer transports the particles (including cells) in the fluid sample as a cell stream to a flow cell, while also directing the sheath fluid to the flow cell. Within the flow cell, a liquid sheath is formed around the cell stream to impart a substantially uniform velocity on the cell stream. The flow cell hydrodynamically focuses the cells within the stream to pass through the center of a light source in a flow cell. Light from the light source can be detected as scatter or by transmission spectroscopy or can be absorbed by one or more components in the sample and re-emitted as luminescence.

### SUMMARY

Aspects of the present disclosure include methods for determining a size of a particle (e.g., cells in a biological sample) in a flow stream from scattered light. Methods according to embodiments include detecting scattered light from a flow stream with two or more photodetectors. In some embodiments, scattered light is detected with two or more side scatter photodetectors. In other embodiments, scattered light is detected with a side scatter photodetector and a forward scatter photodetector. In yet other embodiments, scattered light is detected with a side scatter photodetector and a back scatter photodetector. In still other embodiments, scattered light is detected with a side scatter photodetector, a forward scatter photodetector and a back scatter photodetector. In certain embodiments, the scattered light is detected by a light detection system that includes a first side scatter photodetector positioned at a 90° angle with respect to the incident beam of light irradiation and a second side scatter photodetector positioned at an angle that is less than 90° with respect to the incident beam of light irradiation. In some instances, the first side scatter photodetector is configured to detect light that is scattered at an angle of from 30° to 150° with respect to the incident beam of light irradiation, such as from 60° to 120° and including light that is scattered at an angle of 90° with respect to the incident beam of light irradiation and the second side scatter photodetector is configured to detect light that is scattered at an angle of from 5° to 30° with respect to the incident beam of light irradiation, such as 10° to 30° with respect to the incident beam of light irradiation. In certain embodiments, the second side scatter photodetector is configured to detect both side scattered light and back scattered light. In these embodiments, the back scattered light may be propagated to the detector from the flow stream with a mirror, such as with a mirror having a hole (e.g., to pass irradiating light from the light source).

In determining the size of a particle in the flow stream, methods according to embodiments include generating a data signal from the scattered light with each of the photodetectors, calculating a ratio of data signals from two or more of the photodetectors and determining the size of the particle based on the calculated ratio of the data signals. In some embodiments, methods include calculating a ratio of the data signals between each of the photodetectors. In some instances, determining the size of the particle includes comparing the calculated ratio of the data signals with one or more predetermined ratio values. The calculated ratio of the data signals may be compared with the predetermined ratio values by determining a minimum error margin between the calculated ratio values and the predetermined ratio values. In certain instances, methods include generating a first data signal from scattered light from a first photodetector; generating a second data signal from scattered light from a second photodetector; generating a third data signal from scattered light from a third photodetector; calculating a first ratio, wherein the first ratio comprises a ratio of the second data signal and the first data signal; calculating a second ratio, wherein the second ratio comprises a ratio of the third data signal and the first data signal; calculating a third ratio, wherein the third ratio comprises a ratio of the second data signal and the third data signal; and comparing the first ratio, the second ratio and the third ratio with a set of predetermined ratio values; and determining the size of the particle based on the comparison of the first ratio, the second ratio and the third ratio with a set of predetermined ratio values.

Aspects of the present disclosure include light detection systems. Systems according to certain embodiments include two or more photodetectors configured to detect scattered light from a flow stream. In some embodiments, systems include two or more side scatter photodetectors. In other embodiments, systems include a side scatter photodetector and a forward scatter photodetector. In yet other embodiments, systems include a side scatter photodetector and a back scatter photodetector. In still other embodiments, systems include a side scatter photodetector, a forward scatter photodetector and a back scatter photodetector.

In certain embodiments, the scattered light detection system includes a first side scatter photodetector positioned at a 90° angle with respect to the incident beam of light irradiation and a second side scatter photodetector positioned at an angle that is less than 90° with respect to the incident beam of light irradiation. In some instances, the first side scatter photodetector is configured to detect light that is scattered at an angle of from 30° to 150° with respect to the incident beam of light irradiation, such as from 60° to 120° and including light that is scattered at an angle of 90° with respect to the incident beam of light irradiation and the second side scatter photodetector is configured to detect light that is scattered at an angle of from 5° to 30° with respect to the incident beam of light irradiation, such as 10° to 30° with respect to the incident beam of light irradiation. In certain embodiments, the second side scatter photodetector is configured to detect both side scattered light and back scattered light. In these embodiments, the back scattered light may be propagated to the detector from the flow stream with a mirror, such as with a mirror having a hole (e.g., to pass irradiating light from the light source).

Systems according to certain embodiments include a processor with memory operably coupled to the processor where the memory includes instructions stored thereon, which when executed by the processor, cause the processor to generate a data signal from the scattered light with each of the photodetectors; calculate a ratio of data signals from two or more of the photodetectors; and determine the size of the particle based on the calculated ratio of the data signals. In some instances, the memory includes instructions which when executed by the processor, cause the processor to calculate a ratio of the data signals between each of the photodetectors. In other instances, the method includes instructions which when executed by the processor, cause the processor to compare the calculated ratio of the data signals with one or more predetermined ratio values. In still other instances, the memory includes instructions which when executed by the processor, cause the processor to determine a minimum error margin between the calculated ratio values and the predetermined ratio values. In certain instances, systems include a processor with memory operably coupled to the processor where the memory includes instructions stored thereon, which when executed by the processor, cause the processor to generate a first data signal from scattered light from a first photodetector; generate a second data signal from scattered light from a second photodetector; generate a third data signal from scattered light from a third photodetector; calculate a first ratio, wherein the first ratio comprises a ratio of the second data signal and the first data signal; calculate a second ratio, wherein the second ratio comprises a ratio of the third data signal and the first data signal; calculate a third ratio, wherein the third ratio comprises a ratio of the second data signal and the third data signal; and compare the first ratio, the second ratio and the third ratio with a set of predetermined ratio values; and determine the size of the particle based on the comparison of the first ratio, the second ratio and the third ratio with a set of predetermined ratio values.

In certain embodiments, systems include a light source for irradiating a flow stream. In some embodiments, the light source includes a laser, such as a continuous wave laser. In some embodiments, the light source is a light beam generator that produces a plurality of frequency shifted beams of light (e.g., a first beam of radiofrequency-shifted light and a second beam of radiofrequency-shifted light). In certain instances, the light beam generator includes an acousto-optic deflector, such as an acousto-optic deflector that is operatively coupled to a direct digital synthesizer radiofrequency comb generator. In these instances, the light beam generator is configured to generate a local oscillator beam and a plurality of comb beams (e.g., radiofrequency-shifted local oscillator beam and radiofrequency-shifted comb beams). In some embodiments, the system is a flow cytometer.

The subject systems may also include a computer processor for collecting and outputting data from the measured light of the light detection system. In embodiments, the processor may include memory operably coupled to the processor where the memory includes instructions stored thereon, which when executed by the processor, cause the processor to generate data signals from the light detected by the scatter photodetectors. The memory may further include instructions to differentiate between particles having a diameter of 200 nm or greater and particles having a diameter of less than 200 nm. In certain instances, the memory includes instructions to differentiate between particles having a diameter of from 40 nm to 200 nm. In certain embodiments, the particles may be cells and the subject systems are configured to differentiate between cells based on the size of the cells. In other embodiments, the particles may be nanoparticles and the subject systems are configured to differentiate between nanoparticles based on the size of the nanoparticles.

Aspects of the present disclosure also include integrated circuit devices programmed to determine a size of a particle in a flow stream from scattered light detected by two or more scatter photodetectors operably coupled to the integrated circuit. In some embodiments, the integrated circuit device is programmed to generate a data signal from the scattered light with each of the photodetectors; calculate a ratio of data signals from two or more of the photodetectors; and determine the size of the particle based on the calculated ratio of the data signals. In some instances, the integrated circuit is further programmed to calculate a ratio of the data signals between each of the photodetectors. In other instances, the integrated circuit is further programmed to compare the calculated ratio of the data signals with one or more predetermined ratio values. In still other instances, the integrated circuit is further programmed to determine a minimum error margin between the calculated ratio values and the predetermined ratio values. In certain embodiments, the integrated circuit is programmed to generate a first data signal from scattered light from a first photodetector; generate a second data signal from scattered light from a second photodetector; generate a third data signal from scattered light from a third photodetector; calculate a first ratio, wherein the first ratio comprises a ratio of the second data signal and the first data signal; calculate a second ratio, wherein the second ratio comprises a ratio of the third data signal and the first data signal; calculate a third ratio, wherein the third ratio comprises a ratio of the second data signal and the third data signal; and compare the first ratio, the second ratio and the third ratio with a set of predetermined ratio values; and determine the size of the particle based on the comparison of the first ratio, the second ratio and the third ratio with a set of predetermined ratio values. In some embodiments, the integrated circuit device is a field programmable gate array (FPGA). In other embodiments, the integrated circuit device is an application specific integrated circuit (ASIC). In still other embodiments, the integrated circuit device is a complex programmable logic device (CPLD).

### BRIEF DESCRIPTION OF THE FIGURES

The invention may be best understood from the following detailed description when read in conjunction with the accompanying drawings. Included in the drawings are the following figures:

FIG. 1 depicts a flow chart for determining a size of particle in a flow stream according to certain embodiments.

FIG. 2A-2D depict light angle diagrams of light scattering by particles having different diameters, 50 nm (FIG. 2A), 100 nm (FIG. 2B), 150 nm (FIG. 2C) and 200 nm (FIG. 2D) according to certain embodiments.

FIGS. 3A and 3B depict the ratio of light intensity of scattered light determined at 90° and 0° with respect to the longitudinal axis of light irradiation for extracellular vesicles, silica and polystyrene particles having diameters ranging from 40 nm to 200 nm according to certain embodiments.

FIGS. 4A and 4B depict systems for detecting light scattering by particles in a flow stream according to certain embodiments.

### DETAILED DESCRIPTION

Methods for determining a size of a particle in a flow stream from scattered light are described. Methods according to certain embodiments include detecting scattered light from a flow stream with two or more photodetectors, generating a data signal from the scattered light with each of the photodetectors, calculating a ratio of data signals from two or more of the photodetectors and determining the size of the particle based on the calculated ratio of the data signals. Light detection systems having two or more photodetectors for detecting scattered light from a flow stream are also provided. Integrated circuits (e.g., field programmable gate arrays) programmed to determine the size of a particle from scattered light data signals are also provided.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

As summarized above, the present disclosure provides methods for determining a size of a particle (e.g., a particle having a diameter of 200 nm or less) in a flow stream from scattered light detected by two or more scatter photodetectors (e.g., two or more side scatter photodetectors). In further describing embodiments of the disclosure, methods for determining a size of a particle based on detected scattered light are described first in greater detail. Next, systems for measuring scattered light from a particle in a sample (e.g., a biological sample) are described. Integrated circuit devices (e.g., an FPGA) programmed to determine the size of a particle based on scattered light are also provided.

### Methods for Determining Size of a Particle in an Irradiated Sample in a Flow Stream

Aspects of the disclosure also include methods for determining size of a particle from scattered light of an irradiated flow stream. In practicing methods according to certain embodiments, a sample having particles is irradiated in a flow stream with a light source and scattered light from the sample is detected with a light detection system having two or more light scatter photodetectors. In embodiments, the scatter photodetectors may be side scatter photodetectors, forward scatter photodetectors, back scatter photodetectors and combinations thereof. The term “light scatter” is used herein in its conventional sense to refer to the propagation of light energy from particles in the sample (e.g., flowing in a flow stream) that are deflected from the incident beam path, such as by reflection, refraction or deflection of the beam of light. In some embodiments, scattered light is not luminescence from a component of the particle (e.g., a fluorophore). In embodiments, scattered light according to the present disclosure is not fluorescence or phosphorescence. In certain embodiments, scattered light used to determine the size of particles in the flow stream by the subject methods includes Mie scattering by particles in the flow stream. In other embodiments, scattered light used to determine the size of particles in the flow stream by the subject methods includes Rayleigh scattering by particles in the flow stream. In still other embodiments, scattered light used to determine the size of particles in the flow stream by the subject methods includes Mie scattering and Rayleigh scattering by particles in the flow stream.

As described in greater detail below, methods of the present disclosure provide for determining the size of particles in a flow stream having a diameter of 200 nm or less, such as 190 nm or less, such as 180 nm or less, such as 170 nm or less, such as 160 nm or less, such as 150 nm or less, such as 140 nm or less, such as 130 nm or less, such as 120 nm or less, such as 110 nm or less such as 100 nm or less, such as 90 nm or less, such as 80 nm or less, such as 70 nm or less, such as 60 nm or less, such as 50 nm or less and including particles in a flow stream having a diameter of 40 nm or less. In certain embodiments, methods include determining the size of particles from scattered light having a diameter of from 1 nm to 250 nm, such as from 5 nm to 225 nm, such as from 10 nm to 200 nm, such as from 15 nm to 175 nm, such as from 20 nm to 150 nm, such as from 25 nm to 125 nm, such as from 30 nm to 100 nm and including determining the size of particles from scattered light having a diameter of from 40 nm to 100 nm.

In embodiments, the scattered light may be detected by each photodetector at an angle with respect to the incident beam of light irradiation, such as at an angle of 1° or more, such as 10° or more, such as 15° or more, such as 20° or more, such as 25° or more, such as 30° or more, such as 45° or more, such as 60° or more, such as 75° or more, such as 90° or more, such as 135° or more, such as 150° or more and including where the scattered light detector is configured to detect light from particles in the sample at an angle that is 180° or more with respect to the incident beam of light irradiation. In certain instances, the light scatter photodetectors include a side scatter photodetector, such as where the photodetector is positioned to detect scattered light that is propagated from 30° to 120° with respect to the incident beam of light irradiation, such as from 45° to 105° and including from 60° to 90°. In certain instances, the light scatter detector is a side scatter photodetector positioned at an angle of 90° with respect to the incident beam of light irradiation. In other instances, the light scatter detector is a forward scatter detector, such as where the detector is positioned to detect scattered light that is propagated from 120° to 240° with respect to the incident beam of light irradiation, such as from 100° to 220°, such as from 120° to 200° and including from 140° to 180° with respect to the incident beam of light irradiation. In certain instances, the light scatter detector is a front scatter photodetector positioned to detect scattered light that is propagated at an angle of 180° with respect to the incident beam of light irradiation. In yet other instances, the light scatter detector is a back scatter photodetector positioned to detect scattered light that is propagated from 1° to 30° with respect to the incident beam of light irradiation, such as from 5° to 25° and including from 10° to 20° with respect to the incident beam of light irradiation. In certain instances, scattered light is detected by a back scatter photodetector positioned to detect scattered light that is propagated at an angle of 30° with respect to the incident beam of light irradiation.

Methods of the present disclosure include detecting scattered light with two or more photodetectors. In some embodiments, scattered light is detected with 2 or more side scatter photodetectors, such as 3 or more side scatter photodetectors, such as 4 or more side scatter photodetectors, such as 5 or more side scatter photodetectors, such as 6 or more side scatter photodetectors, such as 7 or more side scatter photodetectors, such as 8 or more side scatter photodetectors, such as 9 or more side scatter photodetectors and including 10 or more side scatter photodetectors. In other embodiments, scattered light is detected with a side scatter photodetector and a forward scatter photodetector, such as 2 or more side scatter photodetectors and a forward scatter photodetector, such as 3 or more side scatter photodetectors and a forward scatter photodetector, such as 4 or more side scatter photodetectors and a forward scatter photodetector, such as 5 or more side scatter photodetectors and a forward scatter photodetector, such as 6 or more side scatter photodetectors and a forward scatter photodetector, such as 7 or more side scatter photodetectors and a forward scatter photodetector, such as 8 or more side scatter photodetectors and a forward scatter photodetector, such as 9 or more side scatter photodetectors and a forward scatter photodetector and including 10 or more side scatter photodetectors and a forward scatter photodetector. In yet other embodiments, scattered light is detected with a side scatter photodetector and a back scatter photodetector, such as 2 or more side scatter photodetectors and a back scatter photodetector, such as 3 or more side scatter photodetectors and a back scatter photodetector, such as 4 or more side scatter photodetectors and a back scatter photodetector, such as 5 or more side scatter photodetectors and a back scatter photodetector, such as 6 or more side scatter photodetectors and a back scatter photodetector, such as 7 or more side scatter photodetectors and a back scatter photodetector, such as 8 or more side scatter photodetectors and a back scatter photodetector, such as 9 or more side scatter photodetectors and a back scatter photodetector and including 10 or more side scatter photodetectors and a back scatter photodetector. In still other embodiments, scattered light is detected with a side scatter photodetector, a forward scatter photodetector and a back scatter photodetector, such as 2 or more side scatter photodetectors, a forward scatter photodetector and a back scatter photodetector, such as 3 or more side scatter photodetectors, a forward scatter photodetector and a back scatter photodetector, such as 4 or more side scatter photodetectors, a forward scatter photodetector and a back scatter photodetector, such as 5 or more side scatter photodetectors, a forward scatter photodetector and a back scatter photodetector, such as 6 or more side scatter photodetectors, a forward scatter photodetector and a back scatter photodetector, such as 7 or more side scatter photodetectors, a forward scatter photodetector and a back scatter photodetector, such as 8 or more side scatter photodetectors, a forward scatter photodetector and a back scatter photodetector, such as 9 or more side scatter photodetectors, a forward scatter photodetector and a back scatter photodetector and including 10 or more side scatter photodetectors, a forward scatter photodetector and a back scatter photodetector.

In certain embodiments, the scattered light is detected by a light detection system that includes a first side scatter photodetector positioned at a 90° angle with respect to the incident beam of light irradiation and a second side scatter photodetector positioned at an angle that is less than 90° with respect to the incident beam of light irradiation. In some instances, the first side scatter photodetector is configured to detect light that is scattered at an angle of from 30° to 150° with respect to the incident beam of light irradiation, such as from 60° to 120° and including light that is scattered at an angle of 90° with respect to the incident beam of light irradiation and the second side scatter photodetector is configured to detect light that is scattered at an angle of from 5° to 30° with respect to the incident beam of light irradiation, such as 10° to 30° with respect to the incident beam of light irradiation. In certain embodiments, the second side scatter photodetector is configured to detect both side scattered light and back scattered light. In these embodiments, the back scattered light may be propagated to the detector from the flow stream with a mirror, such as with a mirror having a hole (e.g., to pass irradiating light from the light source).

The light scatter photodetector may be any suitable photosensor, such as active-pixel sensors (APSs), avalanche photodiode, image sensors, charge-coupled devices (CCDs), intensified charge-coupled devices (ICCDs), complementary metal-oxide semiconductor (CMOS) image sensors or N-type metal-oxide semiconductor (NMOS) image sensors, light emitting diodes, photon counters, bolometers, pyroelectric detectors, photoresistors, photovoltaic cells, photodiodes, photomultiplier tubes, phototransistors, quantum dot photoconductors or photodiodes and combinations thereof, among other types of photodetectors. In embodiments, the light scatter photodetector may include 1 or more photosensor, such as 2 or more, such as 3 or more, such as 5 or more, such as 10 or more and including 25 or more photosensors. In some instances, the light scatter photodetector is a photodetector array. The term “photodetector array” is used in its conventional sense to refer to an arrangement or series of two or more photodetectors that are configured to detect light. In embodiments, photodetector arrays may include 2 or more photodetectors, such as 3 or more photodetectors, such as 4 or more photodetectors, such as 5 or more photodetectors, such as 6 or more photodetectors, such as 7 or more photodetectors, such as 8 or more photodetectors, such as 9 or more photodetectors, such as 10 or more photodetectors, such as 12 or more photodetectors and including 15 or more photodetectors. In certain embodiments, photodetector arrays include 5 photodetectors. The photodetectors may be arranged in any geometric configuration as desired, where arrangements of interest include, but are not limited to a square configuration, rectangular configuration, trapezoidal configuration, triangular configuration, hexagonal configuration, heptagonal configuration, octagonal configuration, nonagonal configuration, decagonal configuration, dodecagonal configuration, circular configuration, oval configuration as well as irregular shaped configurations. The photodetectors in a light scatter photodetector array may be oriented with respect to the other (as referenced in an X-Z plane) at an angle ranging from 10° to 180°, such as from 15° to 170°, such as from 20° to 160°, such as from 25° to 150°, such as from 30° to 120° and including from 45° to 90°.

The light scatter photodetector of the present disclosure are configured to measure collected light at one or more wavelengths, such as at 2 or more wavelengths, such as at 5 or more different wavelengths, such as at 10 or more different wavelengths, such as at 25 or more different wavelengths, such as at 50 or more different wavelengths, such as at 100 or more different wavelengths, such as at 200 or more different wavelengths, such as at 300 or more different wavelengths and including measuring light emitted by a sample in the flow stream at 400 or more different wavelengths.

In some embodiments, the subject photodetectors are configured to measure collected light over a range of wavelengths (e.g., 200 nm-1000 nm). In certain embodiments, detectors of interest are configured to collect spectra of light over a range of wavelengths. For example, systems may include one or more detectors configured to collect spectra of light over one or more of the wavelength ranges of 200 nm-1000 nm. In yet other embodiments, detectors of interest are configured to measure light emitted by a sample in the flow stream at one or more specific wavelengths. In embodiments, the light detection system is configured to measure light continuously or in discrete intervals. In some instances, detectors of interest are configured to take measurements of the collected light continuously. In other instances, the light detection system is configured to take measurements in discrete intervals, such as measuring light every 0.001 millisecond, every 0.01 millisecond, every 0.1 millisecond, every 1 millisecond, every 10 milliseconds, every 100 milliseconds and including every 1000 milliseconds, or some other interval.

In determining the size of a particle in the flow stream, methods according to embodiments include generating a data signal from the scattered light with each of the photodetectors, calculating a ratio of data signals from two or more of the photodetectors and determining the size of the particle based on the calculated ratio of the data signals. In some embodiments, methods include calculating a ratio of the data signals between each of the photodetectors. In some instances, determining the size of the particle includes comparing the calculated ratio of the data signals with one or more predetermined ratio values. The calculated ratio of the data signals may be compared with the predetermined ratio values by determining a minimum error margin between the calculated ratio values and the predetermined ratio values. In certain instances, methods include generating a first data signal from scattered light from a first photodetector; generating a second data signal from scattered light from a second photodetector; generating a third data signal from scattered light from a third photodetector; calculating a first ratio, wherein the first ratio comprises a ratio of the second data signal and the first data signal; calculating a second ratio, wherein the second ratio comprises a ratio of the third data signal and the first data signal; calculating a third ratio, wherein the third ratio comprises a ratio of the second data signal and the third data signal; and comparing the first ratio, the second ratio and the third ratio with a set of predetermined ratio values; and determining the size of the particle based on the comparison of the first ratio, the second ratio and the third ratio with a set of predetermined ratio values.

In some embodiments, methods generating predetermined ratio values for comparing with the data signal ratios as described above. In these embodiments, methods include: 1) irradiating with a light source a particle of predetermined diameter in a flow stream and detecting scattered light with two or more scatter light photodetectors; 2) generating a data signal for each particle with each scatter photodetector; 3) calculating a ratio of each data signal for each photodetector and generating a look-up table with the calculated ratios. An example of a look-up table for a light detection system having three scatter photodetectors is shown in Table 1. In Table 1, the first index indicates the particle and the second index indicates the photodetector channel. The look up table can be expanded for light detection systems having n number of scatter photodetector channels and n number particles having predetermined diameters.

TABLE 1

| Diameter (nm) | S2/S1 | S3/S1 | S2/S3 |
|---|---|---|---|
| d1 | S12/S11 | S13/S11 | S12/S13 |
| d2 | S22/S21 | S23/S21 | S22/S23 |
| d3 | Si2/Si1 | Si3/Si1 | Si2/Si3 |
| dN | SN2/SN1 | SN3/SN1 | SN2/SN3 |

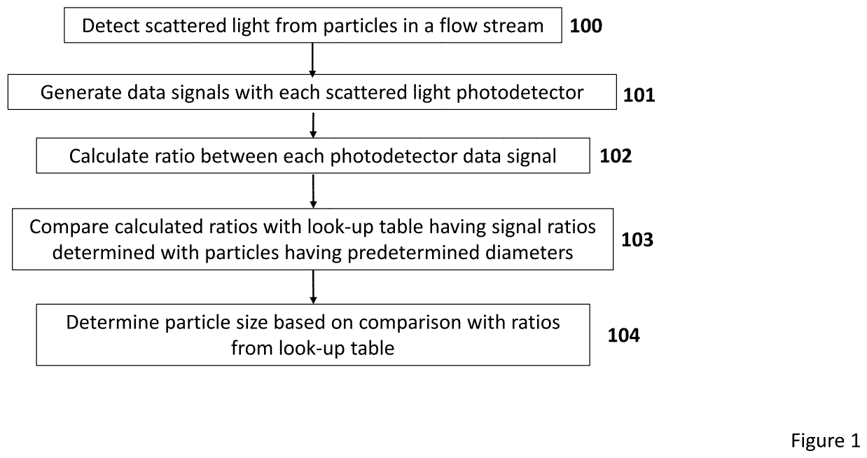

FIG. 1 depicts a flow chart for determining a size of particle in a flow stream according to certain embodiments. At step 100, scattered light from particles in a flow stream is detected. At step 101, data signals are generated from each photodetector (e.g., S₁, S₂, S₃). At step 102, ratios of each of the data signals are calculated (e.g., S2/S1, S3/S1, S2/S3). At step 103, the calculated ratios are compared with a look-up table having signal ratios determined with particles having predetermined diameters where the number in the first column of a row is the value of the particle diameter and linear interpolation of the look-up table provides for accurate diameter computation. Based on the comparison, the diameter the particle of interest is determined (step 104).

In embodiments, the particles irradiated in the flow stream may be cells, such as where the sample in the flow stream is a biological sample. The term “biological sample” is used in its conventional sense to refer to a whole organism, plant, fungi or a subset of animal tissues, cells or component parts which may in certain instances be found in blood, mucus, lymphatic fluid, synovial fluid, cerebrospinal fluid, saliva, bronchoalveolar lavage, amniotic fluid, amniotic cord blood, urine, vaginal fluid and semen. As such, a “biological sample” refers to both the native organism or a subset of its tissues as well as to a homogenate, lysate or extract prepared from the organism or a subset of its tissues, including but not limited to, for example, plasma, serum, spinal fluid, lymph fluid, sections of the skin, respiratory, gastrointestinal, cardiovascular, and genitourinary tracts, tears, saliva, milk, blood cells, tumors, organs. Biological samples may be any type of organismic tissue, including both healthy and diseased tissue (e.g., cancerous, malignant, necrotic, etc.). In certain embodiments, the biological sample is a liquid sample, such as blood or derivative thereof, e.g., plasma, tears, urine, semen, etc., where in some instances the sample is a blood sample, including whole blood, such as blood obtained from venipuncture or fingerstick (where the blood may or may not be combined with any reagents prior to assay, such as preservatives, anticoagulants, etc.).

In certain embodiments the source of the sample is a “mammal” or “mammalian”, where these terms are used broadly to describe organisms which are within the class mammalia, including the orders carnivore (e.g., dogs and cats), rodentia (e.g., mice, guinea pigs, and rats), and primates (e.g., humans, chimpanzees, and monkeys). In some instances, the subjects are humans. The methods may be applied to samples obtained from human subjects of both genders and at any stage of development (i.e., neonates, infant, juvenile, adolescent, adult), where in certain embodiments the human subject is a juvenile, adolescent or adult. While the present invention may be applied to samples from a human subject, it is to be understood that the methods may also be carried-out on samples from other animal subjects (that is, in “non-human subjects”) such as, but not limited to, birds, mice, rats, dogs, cats, livestock and horses.

In practicing the subject methods, a sample (e.g., in a flow stream of a flow cytometer) having particles is irradiated with light from a light source. In some embodiments, the light source is a broadband light source, emitting light having a broad range of wavelengths, such as for example, spanning 50 nm or more, such as 100 nm or more, such as 150 nm or more, such as 200 nm or more, such as 250 nm or more, such as 300 nm or more, such as 350 nm or more, such as 400 nm or more and including spanning 500 nm or more. For example, one suitable broadband light source emits light having wavelengths from 200 nm to 1500 nm. Another example of a suitable broadband light source includes a light source that emits light having wavelengths from 400 nm to 1000 nm. Where methods include irradiating with a broadband light source, broadband light source protocols of interest may include, but are not limited to, a halogen lamp, deuterium arc lamp, xenon arc lamp, stabilized fiber-coupled broadband light source, a broadband LED with continuous spectrum, superluminescent emitting diode, semiconductor light emitting diode, wide spectrum LED white light source, an multi-LED integrated white light source, among other broadband light sources or any combination thereof.

In other embodiments, methods includes irradiating with a narrow band light source emitting a particular wavelength or a narrow range of wavelengths, such as for example with a light source which emits light in a narrow range of wavelengths like a range of 50 nm or less, such as 40 nm or less, such as 30 nm or less, such as 25 nm or less, such as 20 nm or less, such as 15 nm or less, such as 10 nm or less, such as 5 nm or less, such as 2 nm or less and including light sources which emit a specific wavelength of light (i.e., monochromatic light). Where methods include irradiating with a narrow band light source, narrow band light source protocols of interest may include, but are not limited to, a narrow wavelength LED, laser diode or a broadband light source coupled to one or more optical bandpass filters, diffraction gratings, monochromators or any combination thereof.

In certain embodiments, methods include irradiating the flow stream with one or more lasers. As discussed above, the type and number of lasers will vary depending on the sample as well as desired light collected and may be a pulsed laser or continuous wave laser. For example, the laser may be a gas laser, such as a helium-neon laser, argon laser, krypton laser, xenon laser, nitrogen laser, CO₂ laser, CO laser, argon-fluorine (ArF) excimer laser, krypton-fluorine (KrF) excimer laser, xenon chlorine (XeCl) excimer laser or xenon-fluorine (XeF) excimer laser or a combination thereof; a dye laser, such as a stilbene, coumarin or rhodamine laser; a metal-vapor laser, such as a helium-cadmium (HeCd) laser, helium-mercury (HeHg) laser, helium-selenium (HeSe) laser, helium-silver (HeAg) laser, strontium laser, neon-copper (NeCu) laser, copper laser or gold laser and combinations thereof; a solid-state laser, such as a ruby laser, an Nd:YAG laser, NdCrYAG laser, Er:YAG laser, Nd:YLF laser, Nd:YVO₄ laser, Nd:YCa₄O(BO₃)₃ laser, Nd:YCOB laser, titanium sapphire laser, thulim YAG laser, ytterbium YAG laser, ytterbium₂O₃ laser or cerium doped lasers and combinations thereof; a semiconductor diode laser, optically pumped semiconductor laser (OPSL), or a frequency doubled- or frequency tripled implementation of any of the above mentioned lasers.

The sample may be irradiated with one or more of the above mentioned light sources, such as 2 or more light sources, such as 3 or more light sources, such as 4 or more light sources, such as 5 or more light sources and including 10 or more light sources. The light source may include any combination of types of light sources. For example, in some embodiments, the methods include irradiating the sample in the flow stream with an array of lasers, such as an array having one or more gas lasers, one or more dye lasers and one or more solid-state lasers.

The sample may be irradiated with wavelengths ranging from 200 nm to 1500 nm, such as from 250 nm to 1250 nm, such as from 300 nm to 1000 nm, such as from 350 nm to 900 nm and including from 400 nm to 800 nm. For example, where the light source is a broadband light source, the sample may be irradiated with wavelengths from 200 nm to 900 nm. In other instances, where the light source includes a plurality of narrow band light sources, the sample may be irradiated with specific wavelengths in the range from 200 nm to 900 nm. For example, the light source may be plurality of narrow band LEDs (1 nm-25 nm) each independently emitting light having a range of wavelengths between 200 nm to 900 nm. In other embodiments, the narrow band light source includes one or more lasers (such as a laser array) and the sample is irradiated with specific wavelengths ranging from 200 nm to 700 nm, such as with a laser array having gas lasers, excimer lasers, dye lasers, metal vapor lasers and solid-state laser as described above.

Where more than one light source is employed, the sample may be irradiated with the light sources simultaneously or sequentially, or a combination thereof. For example, the sample may be simultaneously irradiated with each of the light sources. In other embodiments, the flow stream is sequentially irradiated with each of the light sources. Where more than one light source is employed to irradiate the sample sequentially, the time each light source irradiates the sample may independently be 0.001 microseconds or more, such as 0.01 microseconds or more, such as 0.1 microseconds or more, such as 1 microsecond or more, such as 5 microseconds or more, such as 10 microseconds or more, such as 30 microseconds or more and including 60 microseconds or more. For example, methods may include irradiating the sample with the light source (e.g. laser) for a duration which ranges from 0.001 microseconds to 100 microseconds, such as from 0.01 microseconds to 75 microseconds, such as from 0.1 microseconds to 50 microseconds, such as from 1 microsecond to 25 microseconds and including from 5 microseconds to 10 microseconds. In embodiments where sample is sequentially irradiated with two or more light sources, the duration sample is irradiated by each light source may be the same or different.

The time period between irradiation by each light source may also vary, as desired, being separated independently by a delay of 0.001 microseconds or more, such as 0.01 microseconds or more, such as 0.1 microseconds or more, such as 1 microsecond or more, such as 5 microseconds or more, such as by 10 microseconds or more, such as by 15 microseconds or more, such as by 30 microseconds or more and including by 60 microseconds or more. For example, the time period between irradiation by each light source may range from 0.001 microseconds to 60 microseconds, such as from 0.01 microseconds to 50 microseconds, such as from 0.1 microseconds to 35 microseconds, such as from 1 microsecond to 25 microseconds and including from 5 microseconds to 10 microseconds. In certain embodiments, the time period between irradiation by each light source is 10 microseconds. In embodiments where sample is sequentially irradiated by more than two (i.e., 3 or more) light sources, the delay between irradiation by each light source may be the same or different.

The sample may be irradiated continuously or in discrete intervals. In some instances, methods include irradiating the sample in the sample with the light source continuously. In other instances, the sample in is irradiated with the light source in discrete intervals, such as irradiating every 0.001 millisecond, every 0.01 millisecond, every 0.1 millisecond, every 1 millisecond, every 10 milliseconds, every 100 milliseconds and including every 1000 milliseconds, or some other interval.

Depending on the light source, the sample may be irradiated from a distance which varies such as 0.01 mm or more, such as 0.05 mm or more, such as 0.1 mm or more, such as 0.5 mm or more, such as 1 mm or more, such as 2.5 mm or more, such as 5 mm or more, such as 10 mm or more, such as 15 mm or more, such as 25 mm or more and including 50 mm or more. Also, the angle or irradiation may also vary, ranging from 10° to 90°, such as from 15° to 85°, such as from 20° to 80°, such as from 25° to 75° and including from 30° to 60°, for example at a 90° angle.

In certain embodiments, methods include irradiating the sample with two or more beams of frequency shifted light. As described above, a light beam generator component may be employed having a laser and an acousto-optic device for frequency shifting the laser light. In these embodiments, methods include irradiating the acousto-optic device with the laser. Depending on the desired wavelengths of light produced in the output laser beam (e.g., for use in irradiating a sample in a flow stream), the laser may have a specific wavelength that varies from 200 nm to 1500 nm, such as from 250 nm to 1250 nm, such as from 300 nm to 1000 nm, such as from 350 nm to 900 nm and including from 400 nm to 800 nm. The acousto-optic device may be irradiated with one or more lasers, such as 2 or more lasers, such as 3 or more lasers, such as 4 or more lasers, such as 5 or more lasers and including 10 or more lasers. The lasers may include any combination of types of lasers. For example, in some embodiments, the methods include irradiating the acousto-optic device with an array of lasers, such as an array having one or more gas lasers, one or more dye lasers and one or more solid-state lasers.

Where more than laser is employed, the acousto-optic device may be irradiated with the lasers simultaneously or sequentially, or a combination thereof. For example, the acousto-optic device may be simultaneously irradiated with each of the lasers. In other embodiments, the acousto-optic device is sequentially irradiated with each of the lasers. Where more than one laser is employed to irradiate the acousto-optic device sequentially, the time each laser irradiates the acousto-optic device may independently be 0.001 microseconds or more, such as 0.01 microseconds or more, such as 0.1 microseconds or more, such as 1 microsecond or more, such as 5 microseconds or more, such as 10 microseconds or more, such as 30 microseconds or more and including 60 microseconds or more. For example, methods may include irradiating the acousto-optic device with the laser for a duration which ranges from 0.001 microseconds to 100 microseconds, such as from 0.01 microseconds to 75 microseconds, such as from 0.1 microseconds to 50 microseconds, such as from 1 microsecond to 25 microseconds and including from 5 microseconds to 10 microseconds. In embodiments where acousto-optic device is sequentially irradiated with two or more lasers, the duration the acousto-optic device is irradiated by each laser may be the same or different.

The time period between irradiation by each laser may also vary, as desired, being separated independently by a delay of 0.001 microseconds or more, such as 0.01 microseconds or more, such as 0.1 microseconds or more, such as 1 microsecond or more, such as 5 microseconds or more, such as by 10 microseconds or more, such as by 15 microseconds or more, such as by 30 microseconds or more and including by 60 microseconds or more. For example, the time period between irradiation by each light source may range from 0.001 microseconds to 60 microseconds, such as from 0.01 microseconds to 50 microseconds, such as from 0.1 microseconds to 35 microseconds, such as from 1 microsecond to 25 microseconds and including from 5 microseconds to 10 microseconds. In certain embodiments, the time period between irradiation by each laser is 10 microseconds. In embodiments where the acousto-optic device is sequentially irradiated by more than two (i.e., 3 or more) lasers, the delay between irradiation by each laser may be the same or different.

The acousto-optic device may be irradiated continuously or in discrete intervals. In some instances, methods include irradiating the acousto-optic device with the laser continuously. In other instances, the acousto-optic device is irradiated with the laser in discrete intervals, such as irradiating every 0.001 millisecond, every 0.01 millisecond, every 0.1 millisecond, every 1 millisecond, every 10 milliseconds, every 100 milliseconds and including every 1000 milliseconds, or some other interval.

Depending on the laser, the acousto-optic device may be irradiated from a distance which varies such as 0.01 mm or more, such as 0.05 mm or more, such as 0.1 mm or more, such as 0.5 mm or more, such as 1 mm or more, such as 2.5 mm or more, such as 5 mm or more, such as 10 mm or more, such as 15 mm or more, such as 25 mm or more and including 50 mm or more. Also, the angle or irradiation may also vary, ranging from 10° to 90°, such as from 15° to 85°, such as from 20° to 80°, such as from 25° to 75° and including from 30° to 60°, for example at a 90° angle.

In embodiments, methods include applying radiofrequency drive signals to the acousto-optic device to generate angularly deflected laser beams. Two or more radiofrequency drive signals may be applied to the acousto-optic device to generate an output laser beam with the desired number of angularly deflected laser beams, such as 3 or more radiofrequency drive signals, such as 4 or more radiofrequency drive signals, such as 5 or more radiofrequency drive signals, such as 6 or more radiofrequency drive signals, such as 7 or more radiofrequency drive signals, such as 8 or more radiofrequency drive signals, such as 9 or more radiofrequency drive signals, such as 10 or more radiofrequency drive signals, such as 15 or more radiofrequency drive signals, such as 25 or more radiofrequency drive signals, such as 50 or more radiofrequency drive signals and including 100 or more radiofrequency drive signals.

The angularly deflected laser beams produced by the radiofrequency drive signals each have an intensity based on the amplitude of the applied radiofrequency drive signal. In some embodiments, methods include applying radiofrequency drive signals having amplitudes sufficient to produce angularly deflected laser beams with a desired intensity. In some instances, each applied radiofrequency drive signal independently has an amplitude from about 0.001 V to about 500 V, such as from about 0.005 V to about 400 V, such as from about 0.01 V to about 300 V, such as from about 0.05 V to about 200 V, such as from about 0.1 V to about 100 V, such as from about 0.5 V to about 75 V, such as from about 1 V to 50 V, such as from about 2 V to 40 V, such as from 3 V to about 30 V and including from about 5 V to about 25 V. Each applied radiofrequency drive signal has, in some embodiments, a frequency of from about 0.001 MHz to about 500 MHz, such as from about 0.005 MHz to about 400 MHz, such as from about 0.01 MHz to about 300 MHz, such as from about 0.05 MHz to about 200 MHz, such as from about 0.1 MHz to about 100 MHz, such as from about 0.5 MHz to about 90 MHz, such as from about 1 MHz to about 75 MHz, such as from about 2 MHz to about 70 MHz, such as from about 3 MHz to about 65 MHz, such as from about 4 MHz to about 60 MHz and including from about 5 MHz to about 50 MHz.

In these embodiments, the angularly deflected laser beams in the output laser beam are spatially separated. Depending on the applied radiofrequency drive signals and desired irradiation profile of the output laser beam, the angularly deflected laser beams may be separated by 0.001 μm or more, such as by 0.005 μm or more, such as by 0.01 μm or more, such as by 0.05 μm or more, such as by 0.1 μm or more, such as by 0.5 μm or more, such as by 1 μm or more, such as by 5 μm or more, such as by 10 μm or more, such as by 100 μm or more, such as by 500 μm or more, such as by 1000 μm or more and including by 5000 μm or more. In some embodiments, the angularly deflected laser beams overlap, such as with an adjacent angularly deflected laser beam along a horizontal axis of the output laser beam. The overlap between adjacent angularly deflected laser beams (such as overlap of beam spots) may be an overlap of 0.001 μm or more, such as an overlap of 0.005 μm or more, such as an overlap of 0.01 μm or more, such as an overlap of 0.05 μm or more, such as an overlap of 0.1 μm or more, such as an overlap of 0.5 μm or more, such as an overlap of 1 μm or more, such as an overlap of 5 μm or more, such as an overlap of 10 μm or more and including an overlap of 100 μm or more.

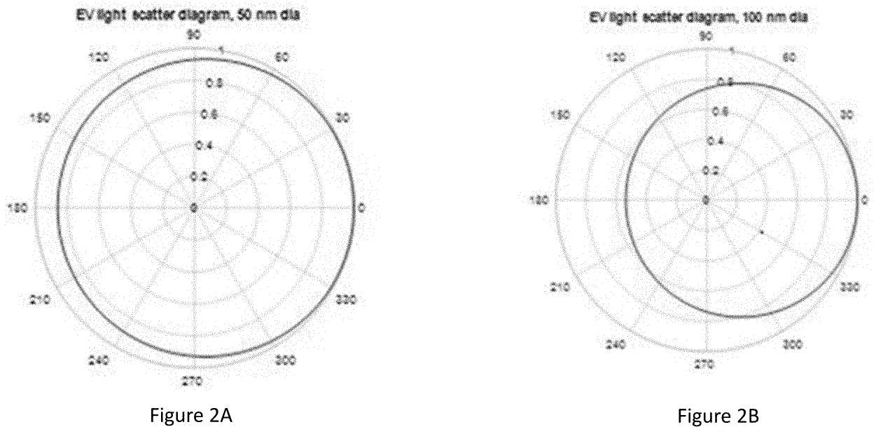

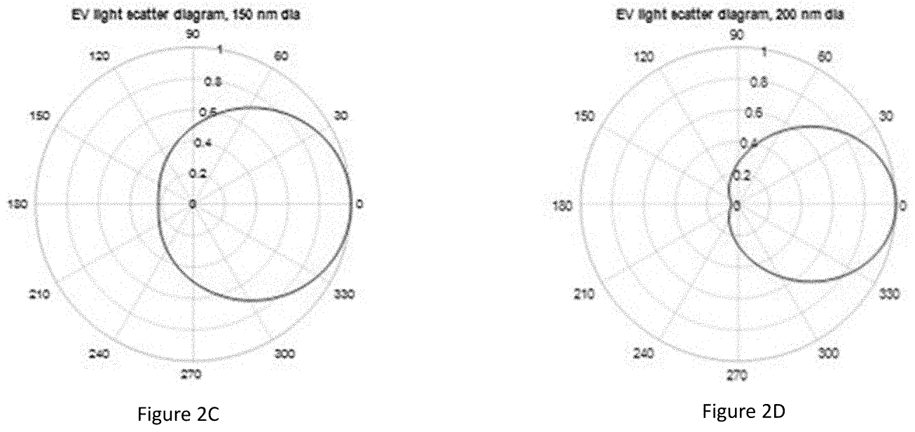

FIGS. 2A-2D depict light angle diagrams of light scattering by particles having different diameters, 50 nm (FIG. 2A), 100 nm (FIG. 2B), 150 nm (FIG. 2C) and 200 nm (FIG. 2D) according to certain embodiments. Each diagram shows an angular distribution of the intensity of the scattered light for a spherical particle calculated based on elastic scatter. Particles in the flow stream were irradiated with 488 nm light (e.g., a 488 nm continuous wave laser) with light polarization that is perpendicular to the incident light. The refractive index of the particle was 1.39 and the refractive index of the medium containing the particles was 1.3355.

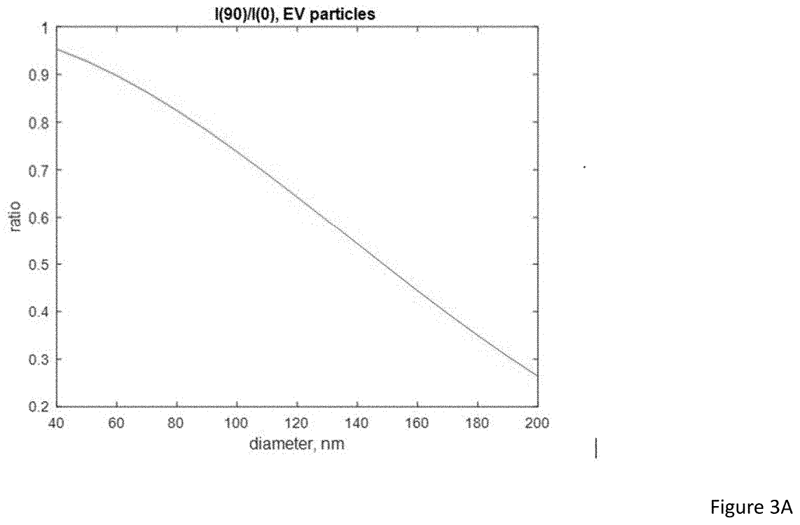

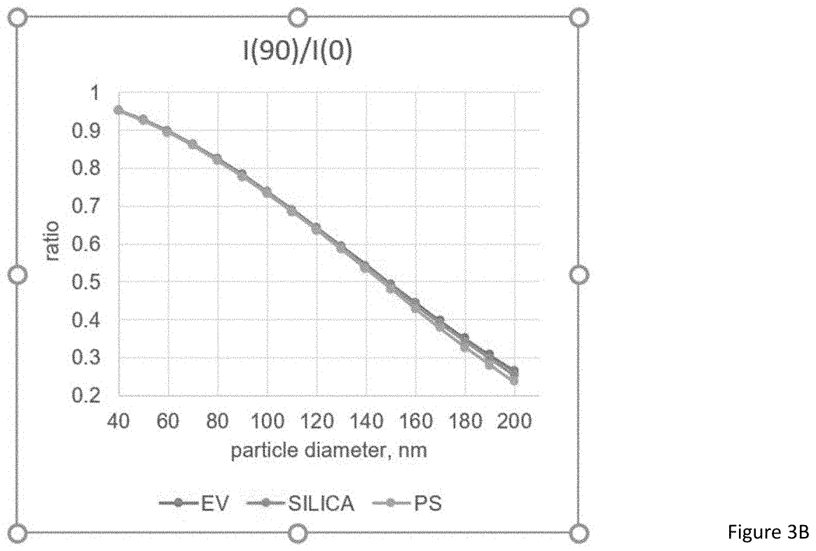

FIGS. 3A and 3B depict the ratio of light intensity of scattered light measured at 90° and 0° with respect to the longitudinal axis of light irradiation for particles having diameters ranging from 40 nm to 200 nm. FIG. 3A depicts the light intensity ratio of scatter intensity at 90° to scatter intensity at 0° computationally calculated for the diameters of extracellular vesicles (EV), polystyrene (PS) particles and silica particles. The wavelength (λ) of light irradiation was 488 nm (e.g., a 488 nm continuous wave laser) where EV particles exhibited a refractive index of 1.3900 with the medium having a refractive index of 1.3355 in air and using perpendicular polarization. FIG. 3B depicts the light intensity ratio of a scatter signal intensity at 90° to the scatter signal intensity at 0° as function of particle diameter. The wavelength (λ) of light irradiation was 488 nm (e.g., a 488 nm continuous wave laser) where EV particles exhibited a refractive index of 1.3900, polystyrene particles exhibited a refractive index of 1.6054 and silica particles exhibited a refractive index of 1.4630 with the medium having a refractive index of 1.3355 in air and using perpendicular polarization.

### Systems for Determining Size of a Particle in an Irradiated Sample in a Flow Stream

Aspects of the present disclosure include light detection systems for determining the size of a particle in a flow stream (e.g., a flow stream of a flow cytometer) from scattered light. In embodiments, light detection systems include two or more light scatter photodetectors. The scatter photodetectors may be side scatter photodetectors, forward scatter photodetectors, back scatter photodetectors and combinations thereof. The term “light scatter” is used herein in its conventional sense to refer to the propagation of light energy from particles in the sample (e.g., flowing in a flow stream) that are deflected from the incident beam path, such as by reflection, refraction or deflection of the beam of light. In some embodiments, scattered light is not luminescence from a component of the particle (e.g., a fluorophore). In embodiments, scattered light according to the present disclosure is not fluorescence or phosphorescence. In certain embodiments, scattered light detected by scatter photodetectors of the subject systems includes Mie scattering by particles in the flow stream. In other embodiments, scattered light detected by scatter photodetectors of the subject systems includes Rayleigh scattering by particles in the flow stream. In still other embodiments, scattered light detected by scatter photodetectors of the subject systems includes Mie scattering and Rayleigh scattering by particles in the flow stream.

In embodiments, scatter light detection systems of interest are configured to determine the size of particles in a flow stream having a diameter of 200 nm or less, such as 190 nm or less, such as 180 nm or less, such as 170 nm or less, such as 160 nm or less, such as 150 nm or less, such as 140 nm or less, such as 130 nm or less, such as 120 nm or less, such as 110 nm or less such as 100 nm or less, such as 90 nm or less, such as 80 nm or less, such as 70 nm or less, such as 60 nm or less, such as 50 nm or less and including particles in a flow stream having a diameter of 40 nm or less. In certain embodiments, systems are configured to determine using scattered light the size of particles having a diameter of from 1 nm to 250 nm, such as from 5 nm to 225 nm, such as from 10 nm to 200 nm, such as from 15 nm to 175 nm, such as from 20 nm to 150 nm, such as from 25 nm to 125 nm, such as from 30 nm to 100 nm and including determining the size of particles from scattered light having a diameter of from 40 nm to 100 nm.

In embodiments, the scattered light may be detected by each photodetector at an angle with respect to the incident beam of light irradiation, such as at an angle of 1° or more, such as 10° or more, such as 15° or more, such as 20° or more, such as 25° or more, such as 30° or more, such as 45° or more, such as 60° or more, such as 75° or more, such as 90° or more, such as 135° or more, such as 150° or more and including where the scattered light detector is configured to detect light from particles in the sample at an angle that is 180° or more with respect to the incident beam of light irradiation. In certain instances, the light scatter photodetectors include a side scatter photodetector, such as where the photodetector is positioned to detect scattered light that is propagated from 30° to 120° with respect to the incident beam of light irradiation, such as from 45° to 105° and including from 60° to 90°. In certain instances, the light scatter detector is a side scatter photodetector positioned at an angle of 90° with respect to the incident beam of light irradiation. In other instances, the light scatter detector is a forward scatter detector, such as where the detector is positioned to detect scattered light that is propagated from 120° to 240° with respect to the incident beam of light irradiation, such as from 100° to 220°, such as from 120° to 200° and including from 140° to 180° with respect to the incident beam of light irradiation. In certain instances, the light scatter detector is a front scatter photodetector positioned to detect scattered light that is propagated at an angle of 180° with respect to the incident beam of light irradiation. In yet other instances, the light scatter detector is a back scatter photodetector positioned to detect scattered light that is propagated from 1° to 30° with respect to the incident beam of light irradiation, such as from 5° to 25° and including from 10° to 20° with respect to the incident beam of light irradiation. In certain instances, scattered light is detected by a back scatter photodetector positioned to detect scattered light that is propagated at an angle of 30° with respect to the incident beam of light irradiation.

Systems of the present disclosure include two or more photodetectors. In some embodiments, scattered light detection systems include 2 or more side scatter photodetectors, such as 3 or more side scatter photodetectors, such as 4 or more side scatter photodetectors, such as 5 or more side scatter photodetectors, such as 6 or more side scatter photodetectors, such as 7 or more side scatter photodetectors, such as 8 or more side scatter photodetectors, such as 9 or more side scatter photodetectors and including 10 or more side scatter photodetectors. In other embodiments, scattered light detection systems include a side scatter photodetector and a forward scatter photodetector, such as 2 or more side scatter photodetectors and a forward scatter photodetector, such as 3 or more side scatter photodetectors and a forward scatter photodetector, such as 4 or more side scatter photodetectors and a forward scatter photodetector, such as 5 or more side scatter photodetectors and a forward scatter photodetector, such as 6 or more side scatter photodetectors and a forward scatter photodetector, such as 7 or more side scatter photodetectors and a forward scatter photodetector, such as 8 or more side scatter photodetectors and a forward scatter photodetector, such as 9 or more side scatter photodetectors and a forward scatter photodetector and including 10 or more side scatter photodetectors and a forward scatter photodetector. In yet other embodiments, scattered light detection systems include a side scatter photodetector and a back scatter photodetector, such as 2 or more side scatter photodetectors and a back scatter photodetector, such as 3 or more side scatter photodetectors and a back scatter photodetector, such as 4 or more side scatter photodetectors and a back scatter photodetector, such as 5 or more side scatter photodetectors and a back scatter photodetector, such as 6 or more side scatter photodetectors and a back scatter photodetector, such as 7 or more side scatter photodetectors and a back scatter photodetector, such as 8 or more side scatter photodetectors and a back scatter photodetector, such as 9 or more side scatter photodetectors and a back scatter photodetector and including 10 or more side scatter photodetectors and a back scatter photodetector. In still other embodiments, scattered light detection systems include a side scatter photodetector, a forward scatter photodetector and a back scatter photodetector, such as 2 or more side scatter photodetectors, a forward scatter photodetector and a back scatter photodetector, such as 3 or more side scatter photodetectors, a forward scatter photodetector and a back scatter photodetector, such as 4 or more side scatter photodetectors, a forward scatter photodetector and a back scatter photodetector, such as 5 or more side scatter photodetectors, a forward scatter photodetector and a back scatter photodetector, such as 6 or more side scatter photodetectors, a forward scatter photodetector and a back scatter photodetector, such as 7 or more side scatter photodetectors, a forward scatter photodetector and a back scatter photodetector, such as 8 or more side scatter photodetectors, a forward scatter photodetector and a back scatter photodetector, such as 9 or more side scatter photodetectors, a forward scatter photodetector and a back scatter photodetector and including 10 or more side scatter photodetectors, a forward scatter photodetector and a back scatter photodetector.

In certain embodiments, the scattered light detection system includes a first side scatter photodetector positioned at a 90° angle with respect to the incident beam of light irradiation and a second side scatter photodetector positioned at an angle that is less than 90° with respect to the incident beam of light irradiation. In some instances, the first side scatter photodetector is configured to detect light that is scattered at an angle of from 30° to 150° with respect to the incident beam of light irradiation, such as from 60° to 120° and including light that is scattered at an angle of 90° with respect to the incident beam of light irradiation and the second side scatter photodetector is configured to detect light that is scattered at an angle of from 5° to 30° with respect to the incident beam of light irradiation, such as 10° to 30° with respect to the incident beam of light irradiation. In certain embodiments, the second side scatter photodetector is configured to detect both side scattered light and back scattered light. In these embodiments, the back scattered light may be propagated to the detector from the flow stream with a mirror, such as with a mirror having a hole (e.g., to pass irradiating light from the light source).

The light scatter photodetector may be any suitable photosensor, such as active-pixel sensors (APSs), avalanche photodiode, image sensors, charge-coupled devices (CCDs), intensified charge-coupled devices (ICCDs), complementary metal-oxide semiconductor (CMOS) image sensors or N-type metal-oxide semiconductor (NMOS) image sensors, light emitting diodes, photon counters, bolometers, pyroelectric detectors, photoresistors, photovoltaic cells, photodiodes, photomultiplier tubes, phototransistors, quantum dot photoconductors or photodiodes and combinations thereof, among other types of photodetectors. In embodiments, the light scatter photodetector may include 1 or more photosensor, such as 2 or more, such as 3 or more, such as 5 or more, such as 10 or more and including 25 or more photosensors. In some instances, the light scatter photodetector is a photodetector array. The term “photodetector array” is used in its conventional sense to refer to an arrangement or series of two or more photodetectors that are configured to detect light. In embodiments, photodetector arrays may include 2 or more photodetectors, such as 3 or more photodetectors, such as 4 or more photodetectors, such as 5 or more photodetectors, such as 6 or more photodetectors, such as 7 or more photodetectors, such as 8 or more photodetectors, such as 9 or more photodetectors, such as 10 or more photodetectors, such as 12 or more photodetectors and including 15 or more photodetectors. In certain embodiments, photodetector arrays include 5 photodetectors. The photodetectors may be arranged in any geometric configuration as desired, where arrangements of interest include, but are not limited to a square configuration, rectangular configuration, trapezoidal configuration, triangular configuration, hexagonal configuration, heptagonal configuration, octagonal configuration, nonagonal configuration, decagonal configuration, dodecagonal configuration, circular configuration, oval configuration as well as irregular shaped configurations. The photodetectors in a light scatter photodetector array may be oriented with respect to the other (as referenced in an X-Z plane) at an angle ranging from 10° to 180°, such as from 15° to 170°, such as from 20° to 160°, such as from 25° to 150°, such as from 30° to 120° and including from 45° to 90°.

The light scatter photodetector of the present disclosure are configured to measure collected light at one or more wavelengths, such as at 2 or more wavelengths, such as at 5 or more different wavelengths, such as at 10 or more different wavelengths, such as at 25 or more different wavelengths, such as at 50 or more different wavelengths, such as at 100 or more different wavelengths, such as at 200 or more different wavelengths, such as at 300 or more different wavelengths and including measuring light emitted by a sample in the flow stream at 400 or more different wavelengths.

In some embodiments, the subject photodetectors are configured to measure collected light over a range of wavelengths (e.g., 200 nm-1000 nm). In certain embodiments, detectors of interest are configured to collect spectra of light over a range of wavelengths. For example, systems may include one or more detectors configured to collect spectra of light over one or more of the wavelength ranges of 200 nm-1000 nm. In yet other embodiments, detectors of interest are configured to measure light emitted by a sample in the flow stream at one or more specific wavelengths. In embodiments, the light detection system is configured to measure light continuously or in discrete intervals. In some instances, detectors of interest are configured to take measurements of the collected light continuously. In other instances, the light detection system is configured to take measurements in discrete intervals, such as measuring light every 0.001 millisecond, every 0.01 millisecond, every 0.1 millisecond, every 1 millisecond, every 10 milliseconds, every 100 milliseconds and including every 1000 milliseconds, or some other interval.

In embodiments of the present disclosure, light detection systems include an optical adjustment component configured to convey light to the light scatter photodetectors. The term “optical adjustment” is used herein in its convention sense to refer to an optical component that changes or adjusts light that is propagated to the light scatter photodetectors. For example, the optical adjustment may be to change the profile of the light beam, the focus of the light beam, the direction of beam propagation or to collimate the light beam.

The amount of light propagated to the light scatter photodetectors through the optical adjustment component may also vary, where in some embodiments, 50% or more of the collected light is conveyed to the light scatter photodetectors, such as 55% or more, such as 60% or more, such as 65% or more, such as 75% or more, such as 80% or more, such as 90% or more and including 95% or more of the light collected by the subject light detection system is conveyed to the light scatter photodetectors through the optical adjustment component. For example, the amount of light propagated to the light scatter photodetectors through the optical adjustment component may range from 25% to 99%, such as from 30% to 95%, such as from 35% to 90%, such as from 40% to 85%, such as from 45% to 80% and including from 50% to 75%.

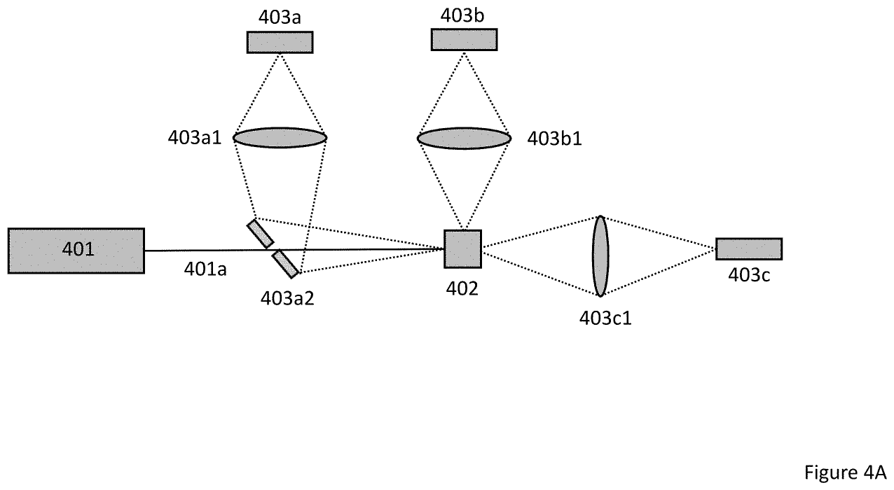

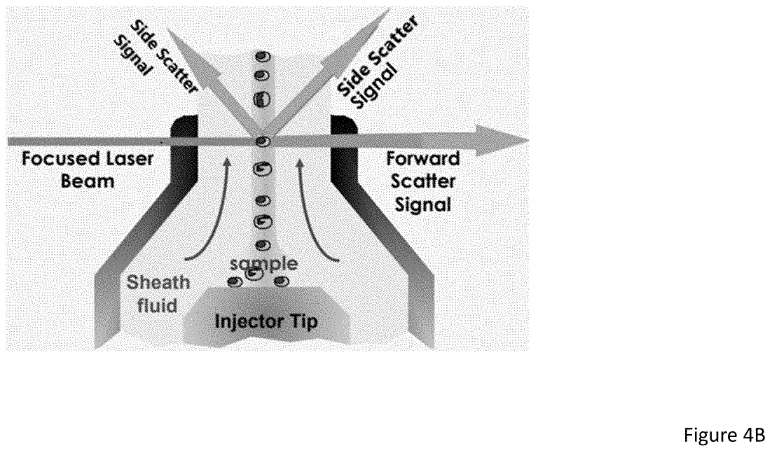

FIGS. 4A and 4B depict systems for detecting light scattering by particles in a flow stream according to certain embodiments. With reference to FIG. 4A, light source 401 irradiates sample flow stream 402 with incident light beam 401a to generate scattered light. Side scatter detectors 403a and 403b are positioned to detect side scattered light collected with lens 403a1 and 403b1, respectively. Light is propagated through lens 403a1 from mirror 403a2 which also collects back scattered light from particles in the sample. Forward scatter detector 403c is positioned to detect forward scattered light collected with lens 403c1. FIG. 4B depicts the interaction of incident focused laser light with a particle in a flow stream. Light deflected by the particle is detected to generate a side scatter data signal and forward scattered light is detected to generate a forward scatter data signal.

In some embodiments, light received by the subject scattered light photodetectors may be conveyed by an optical collection system. The optical collection system may be any suitable light collection protocol that collects and directs the light. In some embodiments, the optical collection system includes fiber optics, such as a fiber optics light relay bundle. In other embodiments, the optical collection system is a free-space light relay system.

In certain embodiments, the optical collection system includes fiber optics. For example, the optical collection system may be a fiber optics light relay bundle and light is conveyed through the fiber optics light relay bundle to the scattered light photodetectors. Any fiber optics light relay system may be employed to propagate light to the scattered light photodetectors. In certain embodiments, suitable fiber optics light relay systems for propagating light to the scattered light photodetectors include, but are not limited to, fiber optics light relay systems such as those described in U.S. Pat. No. 6,809,804, the disclosure of which is herein incorporated by reference.

In other embodiments, the optical collection system is a free-space light relay system. The phrase “free-space light relay” is used herein in its conventional sense to refer to light propagation that employs a configuration of one or more optical components to direct light to the scattered light photodetectors through free-space. In certain embodiments, the free-space light relay system includes a housing having a proximal end and a distal end, the proximal end being in operational communication with the scattered light photodetectors. The free-space relay system may include any combination of different optical adjustment components, such as one or more of lenses, mirrors, slits, pinholes, wavelength separators, or a combination thereof. For example, in some embodiments, free-space light relay systems of interest include one or more focusing lens. In other embodiments, the subject free-space light relay systems include one or more mirrors. In yet other embodiments, the free-space light relay system includes a collimating lens. In certain embodiments, suitable free-space light relay systems for propagating light to the scattered light photodetectors, but are not limited to, light relay systems such as those described in U.S. Pat. Nos. 7,643,142; 7,728,974 and 8,223,445, the disclosures of which is herein incorporated by reference.

Systems according to certain embodiments include a processor with memory operably coupled to the processor where the memory includes instructions stored thereon, which when executed by the processor, cause the processor to generate a data signal from the scattered light with each of the photodetectors; calculate a ratio of data signals from two or more of the photodetectors; and determine the size of the particle based on the calculated ratio of the data signals. In some instances, the memory includes instructions which when executed by the processor, cause the processor to calculate a ratio of the data signals between each of the photodetectors. In other instances, the method includes instructions which when executed by the processor, cause the processor to compare the calculated ratio of the data signals with one or more predetermined ratio values. In still other instances, the memory includes instructions which when executed by the processor, cause the processor to determine a minimum error margin between the calculated ratio values and the predetermined ratio values.

In certain instances, systems include a processor with memory operably coupled to the processor where the memory includes instructions stored thereon, which when executed by the processor, cause the processor to generate a first data signal from scattered light from a first photodetector; generate a second data signal from scattered light from a second photodetector; generate a third data signal from scattered light from a third photodetector; calculate a first ratio, wherein the first ratio comprises a ratio of the second data signal and the first data signal; calculate a second ratio, wherein the second ratio comprises a ratio of the third data signal and the first data signal; calculate a third ratio, wherein the third ratio comprises a ratio of the second data signal and the third data signal; and compare the first ratio, the second ratio and the third ratio with a set of predetermined ratio values; and determine the size of the particle based on the comparison of the first ratio, the second ratio and the third ratio with a set of predetermined ratio values.

Systems of interest for determining the size of a particle in a flow stream include a light source for irradiating the particle in the flow stream. In embodiments, the light source may be any suitable broadband or narrow band source of light. Depending on the components in the sample (e.g., cells, beads, non-cellular particles, etc.), the light source may be configured to emit wavelengths of light that vary, ranging from 200 nm to 1500 nm, such as from 250 nm to 1250 nm, such as from 300 nm to 1000 nm, such as from 350 nm to 900 nm and including from 400 nm to 800 nm. For example, the light source may include a broadband light source emitting light having wavelengths from 200 nm to 900 nm. In other instances, the light source includes a narrow band light source emitting a wavelength ranging from 200 nm to 900 nm. For example, the light source may be a narrow band LED (1 nm-25 nm) emitting light having a wavelength ranging between 200 nm to 900 nm.

In some embodiments, the light source is a laser. Lasers of interest may include pulsed lasers or continuous wave lasers. For example, the laser may be a gas laser, such as a helium-neon laser, argon laser, krypton laser, xenon laser, nitrogen laser, CO₂ laser, CO laser, argon-fluorine (ArF) excimer laser, krypton-fluorine (KrF) excimer laser, xenon chlorine (XeCl) excimer laser or xenon-fluorine (XeF) excimer laser or a combination thereof; a dye laser, such as a stilbene, coumarin or rhodamine laser; a metal-vapor laser, such as a helium-cadmium (HeCd) laser, helium-mercury (HeHg) laser, helium-selenium (HeSe) laser, helium-silver (HeAg) laser, strontium laser, neon-copper (NeCu) laser, copper laser or gold laser and combinations thereof; a solid-state laser, such as a ruby laser, an Nd:YAG laser, NdCrYAG laser, Er:YAG laser, Nd:YLF laser, Nd:YVO₄ laser, Nd:YCa₄O(BO₃)₃ laser, Nd:YCOB laser, titanium sapphire laser, thulim YAG laser, ytterbium YAG laser, ytterbium₂O₃ laser or cerium doped lasers and combinations thereof; a semiconductor diode laser, optically pumped semiconductor laser (OPSL), or a frequency doubled- or frequency tripled implementation of any of the above mentioned lasers.

In other embodiments, the light source is a non-laser light source, such as a lamp, including but not limited to a halogen lamp, deuterium arc lamp, xenon arc lamp, a light-emitting diode, such as a broadband LED with continuous spectrum, superluminescent emitting diode, semiconductor light emitting diode, wide spectrum LED white light source, an multi-LED integrated. In some instances the non-laser light source is a stabilized fiber-coupled broadband light source, white light source, among other light sources or any combination thereof.

In certain embodiments, the light source is a light beam generator that is configured to generate two or more beams of frequency shifted light. In some instances, the light beam generator includes a laser, a radiofrequency generator configured to apply radiofrequency drive signals to an acousto-optic device to generate two or more angularly deflected laser beams. In these embodiments, the laser may be a pulsed lasers or continuous wave laser. For example lasers in light beam generators of interest may be a gas laser, such as a helium-neon laser, argon laser, krypton laser, xenon laser, nitrogen laser, CO2 laser, CO laser, argon-fluorine (ArF) excimer laser, krypton-fluorine (KrF) excimer laser, xenon chlorine (XeCl) excimer laser or xenon-fluorine (XeF) excimer laser or a combination thereof; a dye laser, such as a stilbene, coumarin or rhodamine laser; a metal-vapor laser, such as a helium-cadmium (HeCd) laser, helium-mercury (HeHg) laser, helium-selenium (HeSe) laser, helium-silver (HeAg) laser, strontium laser, neon-copper (NeCu) laser, copper laser or gold laser and combinations thereof; a solid-state laser, such as a ruby laser, an Nd:YAG laser, NdCrYAG laser, Er:YAG laser, Nd:YLF laser, Nd:YVO4 laser, Nd:YCa4O(BO3)3 laser, Nd:YCOB laser, titanium sapphire laser, thulim YAG laser, ytterbium YAG laser, ytterbium2O3 laser or cerium doped lasers and combinations thereof.

The acousto-optic device may be any convenient acousto-optic protocol configured to frequency shift laser light using applied acoustic waves. In certain embodiments, the acousto-optic device is an acousto-optic deflector. The acousto-optic device in the subject system is configured to generate angularly deflected laser beams from the light from the laser and the applied radiofrequency drive signals. The radiofrequency drive signals may be applied to the acousto-optic device with any suitable radiofrequency drive signal source, such as a direct digital synthesizer (DDS), arbitrary waveform generator (AWG), or electrical pulse generator.

In embodiments, a controller is configured to apply radiofrequency drive signals to the acousto-optic device to produce the desired number of angularly deflected laser beams in the output laser beam, such as being configured to apply 3 or more radiofrequency drive signals, such as 4 or more radiofrequency drive signals, such as 5 or more radiofrequency drive signals, such as 6 or more radiofrequency drive signals, such as 7 or more radiofrequency drive signals, such as 8 or more radiofrequency drive signals, such as 9 or more radiofrequency drive signals, such as 10 or more radiofrequency drive signals, such as 15 or more radiofrequency drive signals, such as 25 or more radiofrequency drive signals, such as 50 or more radiofrequency drive signals and including being configured to apply 100 or more radiofrequency drive signals.

In some instances, to produce an intensity profile of the angularly deflected laser beams in the output laser beam, the controller is configured to apply radiofrequency drive signals having an amplitude that varies such as from about 0.001 V to about 500 V, such as from about 0.005 V to about 400 V, such as from about 0.01 V to about 300 V, such as from about 0.05 V to about 200 V, such as from about 0.1 V to about 100 V, such as from about 0.5 V to about 75 V, such as from about 1 V to 50 V, such as from about 2 V to 40 V, such as from 3 V to about 30 V and including from about 5 V to about 25 V. Each applied radiofrequency drive signal has, in some embodiments, a frequency of from about 0.001 MHz to about 500 MHz, such as from about 0.005 MHz to about 400 MHz, such as from about 0.01 MHz to about 300 MHz, such as from about 0.05 MHz to about 200 MHz, such as from about 0.1 MHz to about 100 MHz, such as from about 0.5 MHz to about 90 MHz, such as from about 1 MHz to about 75 MHz, such as from about 2 MHz to about 70 MHz, such as from about 3 MHz to about 65 MHz, such as from about 4 MHz to about 60 MHz and including from about 5 MHz to about 50 MHz.

In certain embodiments, the controller has a processor having memory operably coupled to the processor such that the memory includes instructions stored thereon, which when executed by the processor, cause the processor to produce an output laser beam with angularly deflected laser beams having a desired intensity profile. For example, the memory may include instructions to produce two or more angularly deflected laser beams with the same intensities, such as 3 or more, such as 4 or more, such as 5 or more, such as 10 or more, such as 25 or more, such as 50 or more and including memory may include instructions to produce 100 or more angularly deflected laser beams with the same intensities. In other embodiments, the may include instructions to produce two or more angularly deflected laser beams with different intensities, such as 3 or more, such as 4 or more, such as 5 or more, such as 10 or more, such as 25 or more, such as 50 or more and including memory may include instructions to produce 100 or more angularly deflected laser beams with different intensities.

In certain embodiments, the controller has a processor having memory operably coupled to the processor such that the memory includes instructions stored thereon, which when executed by the processor, cause the processor to produce an output laser beam having increasing intensity from the edges to the center of the output laser beam along the horizontal axis. In these instances, the intensity of the angularly deflected laser beam at the center of the output beam may range from 0.1% to about 99% of the intensity of the angularly deflected laser beams at the edge of the output laser beam along the horizontal axis, such as from 0.5% to about 95%, such as from 1% to about 90%, such as from about 2% to about 85%, such as from about 3% to about 80%, such as from about 4% to about 75%, such as from about 5% to about 70%, such as from about 6% to about 65%, such as from about 7% to about 60%, such as from about 8% to about 55% and including from about 10% to about 50% of the intensity of the angularly deflected laser beams at the edge of the output laser beam along the horizontal axis. In other embodiments, the controller has a processor having memory operably coupled to the processor such that the memory includes instructions stored thereon, which when executed by the processor, cause the processor to produce an output laser beam having an increasing intensity from the edges to the center of the output laser beam along the horizontal axis. In these instances, the intensity of the angularly deflected laser beam at the edges of the output beam may range from 0.1% to about 99% of the intensity of the angularly deflected laser beams at the center of the output laser beam along the horizontal axis, such as from 0.5% to about 95%, such as from 1% to about 90%, such as from about 2% to about 85%, such as from about 3% to about 80%, such as from about 4% to about 75%, such as from about 5% to about 70%, such as from about 6% to about 65%, such as from about 7% to about 60%, such as from about 8% to about 55% and including from about 10% to about 50% of the intensity of the angularly deflected laser beams at the center of the output laser beam along the horizontal axis. In yet other embodiments, the controller has a processor having memory operably coupled to the processor such that the memory includes instructions stored thereon, which when executed by the processor, cause the processor to produce an output laser beam having an intensity profile with a Gaussian distribution along the horizontal axis. In still other embodiments, the controller has a processor having memory operably coupled to the processor such that the memory includes instructions stored thereon, which when executed by the processor, cause the processor to produce an output laser beam having a top hat intensity profile along the horizontal axis.

In embodiments, light beam generators of interest may be configured to produce angularly deflected laser beams in the output laser beam that are spatially separated. Depending on the applied radiofrequency drive signals and desired irradiation profile of the output laser beam, the angularly deflected laser beams may be separated by 0.001 μm or more, such as by 0.005 μm or more, such as by 0.01 μm or more, such as by 0.05 μm or more, such as by 0.1 μm or more, such as by 0.5 μm or more, such as by 1 μm or more, such as by 5 μm or more, such as by 10 μm or more, such as by 100 μm or more, such as by 500 μm or more, such as by 1000 μm or more and including by 5000 μm or more. In some embodiments, systems are configured to produce angularly deflected laser beams in the output laser beam that overlap, such as with an adjacent angularly deflected laser beam along a horizontal axis of the output laser beam. The overlap between adjacent angularly deflected laser beams (such as overlap of beam spots) may be an overlap of 0.001 μm or more, such as an overlap of 0.005 μm or more, such as an overlap of 0.01 μm or more, such as an overlap of 0.05 μm or more, such as an overlap of 0.1 μm or more, such as an overlap of 0.5 μm or more, such as an overlap of 1 μm or more, such as an overlap of 5 μm or more, such as an overlap of 10 μm or more and including an overlap of 100 μm or more.

In certain instances, light beam generators configured to generate two or more beams of frequency shifted light include laser excitation modules as described in U.S. Pat. Nos. 9,423,353; 9,784,661 and 10,006,852 and U.S. Patent Publication Nos. 2017/0133857 and 2017/0350803, the disclosures of which are herein incorporated by reference.

In certain embodiments, systems further include a flow cell configured to propagate the sample in the flow stream. Any convenient flow cell which propagates a fluidic sample to a sample interrogation region may be employed, where in some embodiments, the flow cell includes a proximal cylindrical portion defining a longitudinal axis and a distal frustoconical portion which terminates in a flat surface having the orifice that is transverse to the longitudinal axis. The length of the proximal cylindrical portion (as measured along the longitudinal axis) may vary ranging from 1 mm to 15 mm, such as from 1.5 mm to 12.5 mm, such as from 2 mm to 10 mm, such as from 3 mm to 9 mm and including from 4 mm to 8 mm. The length of the distal frustoconical portion (as measured along the longitudinal axis) may also vary, ranging from 1 mm to 10 mm, such as from 2 mm to 9 mm, such as from 3 mm to 8 mm and including from 4 mm to 7 mm. The diameter of the of the flow cell nozzle chamber may vary, in some embodiments, ranging from 1 mm to 10 mm, such as from 2 mm to 9 mm, such as from 3 mm to 8 mm and including from 4 mm to 7 mm.

In certain instances, the flow cell does not include a cylindrical portion and the entire flow cell inner chamber is frustoconically shaped. In these embodiments, the length of the frustoconical inner chamber (as measured along the longitudinal axis transverse to the nozzle orifice), may range from 1 mm to 15 mm, such as from 1.5 mm to 12.5 mm, such as from 2 mm to 10 mm, such as from 3 mm to 9 mm and including from 4 mm to 8 mm. The diameter of the proximal portion of the frustoconical inner chamber may range from 1 mm to 10 mm, such as from 2 mm to 9 mm, such as from 3 mm to 8 mm and including from 4 mm to 7 mm.

In some embodiments, the sample flow stream emanates from an orifice at the distal end of the flow cell. Depending on the desired characteristics of the flow stream, the flow cell orifice may be any suitable shape where cross-sectional shapes of interest include, but are not limited to: rectilinear cross sectional shapes, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. In certain embodiments, flow cell of interest has a circular orifice. The size of the nozzle orifice may vary, in some embodiments ranging from 1 μm to 20000 μm, such as from 2 μm to 17500 μm, such as from 5 μm to 15000 μm, such as from 10 μm to 12500 μm, such as from 15 μm to 10000 μm, such as from 25 μm to 7500 μm, such as from 50 μm to 5000 μm, such as from 75 μm to 1000 μm, such as from 100 μm to 750 μm and including from 150 μm to 500 μm. In certain embodiments, the nozzle orifice is 100 μm.

In some embodiments, the flow cell includes a sample injection port configured to provide a sample to the flow cell. In embodiments, the sample injection system is configured to provide suitable flow of sample to the flow cell inner chamber. Depending on the desired characteristics of the flow stream, the rate of sample conveyed to the flow cell chamber by the sample injection port may be 1 μL/min or more, such as 2 μL/min or more, such as 3 μL/min or more, such as 5 μL/min or more, such as 10 μL/min or more, such as 15 μL/min or more, such as 25 μL/min or more, such as 50 μL/min or more and including 100 μL/min or more, where in some instances the rate of sample conveyed to the flow cell chamber by the sample injection port is 1 μL/sec or more, such as 2 μL/sec or more, such as 3 μL/sec or more, such as 5 μL/sec or more, such as 10 μL/sec or more, such as 15 μL/sec or more, such as 25 μL/sec or more, such as 50 μL/sec or more and including 100 μL/sec or more.

The sample injection port may be an orifice positioned in a wall of the inner chamber or may be a conduit positioned at the proximal end of the inner chamber. Where the sample injection port is an orifice positioned in a wall of the inner chamber, the sample injection port orifice may be any suitable shape where cross-sectional shapes of interest include, but are not limited to: rectilinear cross sectional shapes, e.g., squares, rectangles, trapezoids, triangles, hexagons, etc., curvilinear cross-sectional shapes, e.g., circles, ovals, etc., as well as irregular shapes, e.g., a parabolic bottom portion coupled to a planar top portion. In certain embodiments, the sample injection port has a circular orifice. The size of the sample injection port orifice may vary depending on shape, in certain instances, having an opening ranging from 0.1 mm to 5.0 mm, e.g., 0.2 to 3.0 mm, e.g., 0.5 mm to 2.5 mm, such as from 0.75 mm to 2.25 mm, such as from 1 mm to 2 mm and including from 1.25 mm to 1.75 mm, for example 1.5 mm.

In certain instances, the sample injection port is a conduit positioned at a proximal end of the flow cell inner chamber. For example, the sample injection port may be a conduit positioned to have the orifice of the sample injection port in line with the flow cell orifice. Where the sample injection port is a conduit positioned in line with the flow cell orifice, the cross-sectional shape of the sample injection tube may be any suitable shape where cross-sectional shapes of interest include, but are not limited to: rectilinear cross sectional shapes, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. The orifice of the conduit may vary depending on shape, in certain instances, having an opening ranging from 0.1 mm to 5.0 mm, e.g., 0.2 to 3.0 mm, e.g., 0.5 mm to 2.5 mm, such as from 0.75 mm to 2.25 mm, such as from 1 mm to 2 mm and including from 1.25 mm to 1.75 mm, for example 1.5 mm. The shape of the tip of the sample injection port may be the same or different from the cross-section shape of the sample injection tube. For example, the orifice of the sample injection port may include a beveled tip having a bevel angle ranging from 1° to 10°, such as from 2° to 9°, such as from 3° to 8°, such as from 4° to 7° and including a bevel angle of 5°.

In some embodiments, the flow cell also includes a sheath fluid injection port configured to provide a sheath fluid to the flow cell. In embodiments, the sheath fluid injection system is configured to provide a flow of sheath fluid to the flow cell inner chamber, for example in conjunction with the sample to produce a laminated flow stream of sheath fluid surrounding the sample flow stream. Depending on the desired characteristics of the flow stream, the rate of sheath fluid conveyed to the flow cell chamber by the may be 254/sec or more, such as 50 μL/sec or more, such as 75 μL/sec or more, such as 100 μL/sec or more, such as 250 μL/sec or more, such as 500 μL/sec or more, such as 750 μL/sec or more, such as 1000 μL/sec or more and including 2500 μL/sec or more.

In some embodiments, the sheath fluid injection port is an orifice positioned in a wall of the inner chamber. The sheath fluid injection port orifice may be any suitable shape where cross-sectional shapes of interest include, but are not limited to: rectilinear cross sectional shapes, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. The size of the sample injection port orifice may vary depending on shape, in certain instances, having an opening ranging from 0.1 mm to 5.0 mm, e.g., 0.2 to 3.0 mm, e.g., 0.5 mm to 2.5 mm, such as from 0.75 mm to 2.25 mm, such as from 1 mm to 2 mm and including from 1.25 mm to 1.75 mm, for example 1.5 mm.

In some embodiments, systems further include a pump in fluid communication with the flow cell to propagate the flow stream through the flow cell. Any convenient fluid pump protocol may be employed to control the flow of the flow stream through the flow cell. In certain instances, systems include a peristaltic pump, such as a peristaltic pump having a pulse damper. The pump in the subject systems is configured to convey fluid through the flow cell at a rate suitable for detecting light from the sample in the flow stream. In some instances, the rate of sample flow in the flow cell is 1 μL/min (microliter per minute) or more, such as 2 μL/min or more, such as 3 μL/min or more, such as 5 μL/min or more, such as 10 μL/min or more, such as 25 μL/min or more, such as 50 μL/min or more, such as 75 μL/min or more, such as 100 μL/min or more, such as 250 μL/min or more, such as 500 μL/min or more, such as 750 μL/min or more and including 1000 μL/min or more. For example, the system may include a pump that is configured to flow sample through the flow cell at a rate that ranges from 1 μL/min to 500 μL/min, such as from 1 uL/min to 250 uL/min, such as from 1 uL/min to 100 uL/min, such as from 2 μL/min to 90 μL/min, such as from 3 μL/min to 80 μL/min, such as from 4 μL/min to 70 μL/min, such as from 5 μL/min to 60 μL/min and including rom 10 μL/min to 50 μL/min. In certain embodiments, the flow rate of the flow stream is from 5 μL/min to 6 μL/min.

In certain embodiments, the subject systems are flow cytometric systems employing the above described light detection system for detecting light emitted by a sample in a flow stream. In certain embodiments, the subject systems are flow cytometric systems. Suitable flow cytometry systems may include, but are not limited to those described in Ormerod (ed.), Flow Cytometry: A Practical Approach, Oxford Univ. Press (1997); Jaroszeski et al. (eds.), Flow Cytometry Protocols, Methods in Molecular Biology No. 91, Humana Press (1997); Practical Flow Cytometry, 3rd ed., Wiley-Liss (1995); Virgo, et al. (2012) Ann Clin Biochem. January; 49 (pt 1): 17-28; Linden, et. al., Semin Throm Hemost. 2004 October; 30(5):502-11; Alison, et al. J Pathol, 2010 December; 222(4):335-344; and Herbig, et al. (2007) Crit Rev Ther Drug Carrier Syst. 24(3):203-255; the disclosures of which are incorporated herein by reference. In certain instances, flow cytometry systems of interest include BD Biosciences FACSCanto™ II flow cytometer, BD Accuri™ flow cytometer, BD Biosciences FACSCelesta™ flow cytometer, BD Biosciences FACSLyric™ flow cytometer, BD Biosciences FACSVerse™ flow cytometer, BD Biosciences FACSymphony™ flow cytometer BD Biosciences LSRFortessa™ flow cytometer, BD Biosciences LSRFortess™ X-20 flow cytometer and BD Biosciences FACSCalibur™ cell sorter, a BD Biosciences FACSCount™ cell sorter, BD Biosciences FACSLyric™ cell sorter and BD Biosciences Via™ cell sorter BD Biosciences Influx™ cell sorter, BD Biosciences Jazz™ cell sorter, BD Biosciences Aria™ cell sorters and BD Biosciences FACSMelody™ cell sorter, or the like.

In some embodiments, the subject particle sorting systems are flow cytometric systems, such those described in U.S. Pat. Nos. 10,006,852; 9,952,076; 9,933,341; 9,784,661; 9,726,527; 9,453,789; 9,200,334; 9,097,640; 9,095,494; 9,092,034; 8,975,595; 8,753,573; 8,233,146; 8,140,300; 7,544,326; 7,201,875; 7,129,505; 6,821,740; 6,813,017; 6,809,804; 6,372,506; 5,700,692; 5,643,796; 5,627,040; 5,620,842; 5,602,039; the disclosure of which are herein incorporated by reference in their entirety.

In certain instances, the subject systems are flow cytometry systems configured for imaging particles in a flow stream by fluorescence imaging using radiofrequency tagged emission (FIRE), such as those described in Diebold, et al. Nature Photonics Vol. 7(10); 806-810 (2013) as well as described in U.S. Pat. Nos. 9,423,353; 9,784,661 and 10,006,852 and U.S. Patent Publication Nos. 2017/0133857 and 2017/0350803, the disclosures of which are herein incorporated by reference.

### Computer-Controlled Systems

Aspects of the present disclosure further include computer controlled systems for practicing the subject methods, where the systems further include one or more computers for complete automation or partial automation of a system for practicing methods described herein. In some embodiments, systems include a computer having a computer readable storage medium with a computer program stored thereon, where the computer program when loaded on the computer includes instructions for irradiating a flow stream with a light source, algorithm for detecting scattered light from the irradiated flow stream and in certain instances, algorithm for generating a data signal from the scattered light with each of the photodetectors; calculating a ratio of data signals from two or more of the photodetectors; and determining the size of the particle based on the calculated ratio of the data signals. In certain instances, systems include a computer having a computer readable storage medium with a computer program stored thereon, where the computer program when loaded on the computer further includes algorithm for generating a first data signal from scattered light from a first photodetector; generating a second data signal from scattered light from a second photodetector; generating a third data signal from scattered light from a third photodetector; calculating a first ratio, wherein the first ratio comprises a ratio of the second data signal and the first data signal; calculating a second ratio, wherein the second ratio comprises a ratio of the third data signal and the first data signal; calculating a third ratio, wherein the third ratio comprises a ratio of the second data signal and the third data signal; and comparing the first ratio, the second ratio and the third ratio with a set of predetermined ratio values; and determining the size of the particle based on the comparison of the first ratio, the second ratio and the third ratio with a set of predetermined ratio values.

In certain embodiments, systems include a computer having a computer readable storage medium with a computer program stored thereon, where the computer program when loaded on the computer further includes algorithm for generating two or more beams of frequency shifted light with a light beam generator component for irradiating the flow stream. In these instances, the system includes algorithm for applying radiofrequency drive signals (such as with a DDS as described above) to an acousto-optic device (e.g., acousto-optic deflector) and irradiating the acousto-optic device with a laser to generate a plurality of radiofrequency shifted, spatially separated beams of light.

In embodiments, the system includes an input module, a processing module and an output module. The subject systems may include both hardware and software components, where the hardware components may take the form of one or more platforms, e.g., in the form of servers, such that the functional elements, i.e., those elements of the system that carry out specific tasks (such as managing input and output of information, processing information, etc.) of the system may be carried out by the execution of software applications on and across the one or more computer platforms represented of the system.

Systems may include a display and operator input device. Operator input devices may, for example, be a keyboard, mouse, or the like. The processing module includes a processor which has access to a memory having instructions stored thereon for performing the steps of the subject methods. The processing module may include an operating system, a graphical user interface (GUI) controller, a system memory, memory storage devices, and input-output controllers, cache memory, a data backup unit, and many other devices. The processor may be a commercially available processor or it may be one of other processors that are or will become available. The processor executes the operating system and the operating system interfaces with firmware and hardware in a well-known manner, and facilitates the processor in coordinating and executing the functions of various computer programs that may be written in a variety of programming languages, such as Java, Perl, C++, other high level or low level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques. The processor may be any suitable analog or digital system. In some embodiments, processors include analog electronics which allows the user to manually align a light source with the flow stream based on the first and second light signals. In some embodiments, the processor includes analog electronics which provide feedback control, such as for example negative feedback control.

The system memory may be any of a variety of known or future memory storage devices. Examples include any commonly available random access memory (RAM), magnetic medium such as a resident hard disk or tape, an optical medium such as a read and write compact disc, flash memory devices, or other memory storage device. The memory storage device may be any of a variety of known or future devices, including a compact disk drive, a tape drive, a removable hard disk drive, or a diskette drive. Such types of memory storage devices typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with the memory storage device.

In some embodiments, a computer program product is described comprising a computer usable medium having control logic (computer software program, including program code) stored therein. The control logic, when executed by the processor the computer, causes the processor to perform functions described herein. In other embodiments, some functions are implemented primarily in hardware using, for example, a hardware state machine. Implementation of the hardware state machine so as to perform the functions described herein will be apparent to those skilled in the relevant arts.

Memory may be any suitable device in which the processor can store and retrieve data, such as magnetic, optical, or solid state storage devices (including magnetic or optical disks or tape or RAM, or any other suitable device, either fixed or portable). The processor may include a general purpose digital microprocessor suitably programmed from a computer readable medium carrying necessary program code. Programming can be provided remotely to processor through a communication channel, or previously saved in a computer program product such as memory or some other portable or fixed computer readable storage medium using any of those devices in connection with memory. For example, a magnetic or optical disk may carry the programming, and can be read by a disk writer/reader. Systems of the invention also include programming, e.g., in the form of computer program products, algorithms for use in practicing the methods as described above. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; portable flash drive; and hybrids of these categories such as magnetic/optical storage media.

The processor may also have access to a communication channel to communicate with a user at a remote location. By remote location is meant the user is not directly in contact with the system and relays input information to an input manager from an external device, such as a a computer connected to a Wide Area Network (“WAN”), telephone network, satellite network, or any other suitable communication channel, including a mobile telephone (i.e., smartphone).

In some embodiments, systems according to the present disclosure may be configured to include a communication interface. In some embodiments, the communication interface includes a receiver and/or transmitter for communicating with a network and/or another device. The communication interface can be configured for wired or wireless communication, including, but not limited to, radio frequency (RF) communication (e.g., Radio-Frequency Identification (RFID), Zigbee communication protocols, WiFi, infrared, wireless Universal Serial Bus (USB), Ultra Wide Band (UWB), Bluetooth® communication protocols, and cellular communication, such as code division multiple access (CDMA) or Global System for Mobile communications (GSM).

In one embodiment, the communication interface is configured to include one or more communication ports, e.g., physical ports or interfaces such as a USB port, an RS-232 port, or any other suitable electrical connection port to allow data communication between the subject systems and other external devices such as a computer terminal (for example, at a physician's office or in hospital environment) that is configured for similar complementary data communication.

In one embodiment, the communication interface is configured for infrared communication, Bluetooth® communication, or any other suitable wireless communication protocol to enable the subject systems to communicate with other devices such as computer terminals and/or networks, communication enabled mobile telephones, personal digital assistants, or any other communication devices which the user may use in conjunction.

In one embodiment, the communication interface is configured to provide a connection for data transfer utilizing Internet Protocol (IP) through a cell phone network, Short Message Service (SMS), wireless connection to a personal computer (PC) on a Local Area Network (LAN) which is connected to the internet, or WiFi connection to the internet at a WiFi hotspot.

In one embodiment, the subject systems are configured to wirelessly communicate with a server device via the communication interface, e.g., using a common standard such as 802.11 or Bluetooth® RF protocol, or an IrDA infrared protocol. The server device may be another portable device, such as a smart phone, Personal Digital Assistant (PDA) or notebook computer; or a larger device such as a desktop computer, appliance, etc. In some embodiments, the server device has a display, such as a liquid crystal display (LCD), as well as an input device, such as buttons, a keyboard, mouse or touch-screen.

In some embodiments, the communication interface is configured to automatically or semi-automatically communicate data stored in the subject systems, e.g., in an optional data storage unit, with a network or server device using one or more of the communication protocols and/or mechanisms described above.

Output controllers may include controllers for any of a variety of known display devices for presenting information to a user, whether a human or a machine, whether local or remote. If one of the display devices provides visual information, this information typically may be logically and/or physically organized as an array of picture elements. A graphical user interface (GUI) controller may include any of a variety of known or future software programs for providing graphical input and output interfaces between the system and a user, and for processing user inputs. The functional elements of the computer may communicate with each other via system bus. Some of these communications may be accomplished in alternative embodiments using network or other types of remote communications. The output manager may also provide information generated by the processing module to a user at a remote location, e.g., over the Internet, phone or satellite network, in accordance with known techniques. The presentation of data by the output manager may be implemented in accordance with a variety of known techniques. As some examples, data may include SQL, HTML or XML documents, email or other files, or data in other forms. The data may include Internet URL addresses so that a user may retrieve additional SQL, HTML, XML, or other documents or data from remote sources. The one or more platforms present in the subject systems may be any type of known computer platform or a type to be developed in the future, although they typically will be of a class of computer commonly referred to as servers. However, they may also be a main-frame computer, a work station, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows NT®, Windows XP, Windows 7, Windows 8, iOS, Sun Solaris, Linux, OS/400, Compaq Tru64 Unix, SGI IRIX, Siemens Reliant Unix, and others.

### Integrated Circuit Devices

Aspects of the present disclosure also include integrated circuit devices programmed to determine a size of a particle in a flow stream from scattered light detected by two or more scatter photodetectors operably coupled to the integrated circuit. In some embodiments, integrated circuit devices of interest include a field programmable gate array (FPGA). In other embodiments, integrated circuit devices include an application specific integrated circuit (ASIC). In yet other embodiments, integrated circuit devices include a complex programmable logic device (CPLD).

In some embodiments, the integrated circuit device is programmed to: generate a data signal from the scattered light with each of the photodetectors; calculate a ratio of data signals from two or more of the photodetectors; and determine the size of the particle based on the calculated ratio of the data signals. In some instances, the integrated circuit is further programmed to calculate a ratio of the data signals between each of the photodetectors. In other instances, the integrated circuit is further programmed to compare the calculated ratio of the data signals with one or more predetermined ratio values. In still other instances, the integrated circuit is further programmed to determine a minimum error margin between the calculated ratio values and the predetermined ratio values.

In certain embodiments, the integrated circuit is programmed to generate a first data signal from scattered light from a first photodetector; generate a second data signal from scattered light from a second photodetector; generate a third data signal from scattered light from a third photodetector; calculate a first ratio, wherein the first ratio comprises a ratio of the second data signal and the first data signal; calculate a second ratio, wherein the second ratio comprises a ratio of the third data signal and the first data signal; calculate a third ratio, wherein the third ratio comprises a ratio of the second data signal and the third data signal; and compare the first ratio, the second ratio and the third ratio with a set of predetermined ratio values; and determine the size of the particle based on the comparison of the first ratio, the second ratio and the third ratio with a set of predetermined ratio values.

In some embodiments, the integrated circuit is programmed to generate predetermined ratio values for comparing with the data signal ratios as described above. In these embodiments, the integrated circuit is programmed to generate a data signal for each particle having a predetermined diameter with each scatter photodetector; calculate a ratio of each data signal for each photodetector and generate a look-up table with the calculated ratios. In certain embodiments, the integrated circuit devices are programmed to compare the calculated ratios of the photodetector signals for particles of unknown diameters with the look-up table values determined for particles of predetermined diameters to determine the size of a particle of interest in the flow stream.

### Kits

Aspects of the invention further include kits, where kits include two or more scatter photodetectors and an optical adjustment component to convey light to a light scatter photodetectors. Kits may further include other optical adjustment components as described here, such as obscuration components including optical apertures, slits and obscuration discs and scatter bars. Kits according to certain embodiments also include optical components for conveying light to the light scatter photodetectors, such as collimating lenses, mirrors, wavelength separators, pinholes, etc. Kits may also include an optical collection component, such as fiber optics (e.g., fiber optics relay bundle) or components for a free-space relay system. In some instances, kits further include one or more photodetectors, such as photomultiplier tubes (e.g., metal package photomultiplier tubes). In certain embodiments, kits include one or more components of a light beam generator, such as a direct digital synthesizer, an acousto-optic deflector, a beam combining lens and a Powell lens.

In some instances, the kits can include one or more assay components (e.g., labeled reagents, buffers, etc., such as described above). In some instances, the kits may further include a sample collection device, e.g., a lance or needle configured to prick skin to obtain a whole blood sample, a pipette, etc., as desired.

The various assay components of the kits may be present in separate containers, or some or all of them may be pre-combined. For example, in some instances, one or more components of the kit, e.g., two or more light scatter photodetectors are present in a sealed pouch, e.g., a sterile foil pouch or envelope.

In addition to the above components, the subject kits may further include (in certain embodiments) instructions for practicing the subject methods. These instructions may be present in the subject kits in a variety of forms, one or more of which may be present in the kit. One form in which these instructions may be present is as printed information on a suitable medium or substrate, e.g., a piece or pieces of paper on which the information is printed, in the packaging of the kit, in a package insert, and the like. Yet another form of these instructions is a computer readable medium, e.g., diskette, compact disk (CD), portable flash drive, and the like, on which the information has been recorded. Yet another form of these instructions that may be present is a website address which may be used via the internet to access the information at a removed site.

### Utility

The subject methods and light detection systems find use where the characterization of a sample by optical properties, in particular where identification and differentiation of cells in a sample, is desired. In some embodiments, the systems and methods described herein find use in flow cytometry characterization of biological samples. In certain instances, the present disclosure finds use in enhancing measurement of light collected from a sample that is irradiated in a flow stream in a flow cytometer. Embodiments of the present disclosure find use where enhancing the effectiveness of measurements in flow cytometry are desired, such as in research and high throughput laboratory testing. The present disclosure also finds use where it is desirable to provide a flow cytometer with improved cell sorting accuracy, enhanced particle collection, reduced energy consumption, particle charging efficiency, more accurate particle charging and enhanced particle deflection during cell sorting.

The present disclosure also finds use in applications where cells prepared from a biological sample may be desired for research, laboratory testing or for use in therapy. In some embodiments, the subject methods and devices may facilitate the obtaining individual cells prepared from a target fluidic or tissue biological sample. For example, the subject methods and systems facilitate obtaining cells from fluidic or tissue samples to be used as a research or diagnostic specimen for diseases such as cancer. Likewise, the subject methods and systems facilitate obtaining cells from fluidic or tissue samples to be used in therapy. Methods and devices of the present disclosure allow for separating and collecting cells from a biological sample (e.g., organ, tissue, tissue fragment, fluid) with enhanced efficiency and low cost as compared to traditional flow cytometry systems.

Although the foregoing invention has been described in some detail by way of illustration and example for purposes of clarity of understanding, it is readily apparent to those of ordinary skill in the art in light of the teachings of this disclosure that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A method comprising determining a size of a particle in a flow stream from scattered light detected by two or more side scatter photodetectors.

2. The method according to claim 1, wherein the side scatter photodetectors are positioned parallel to the longitudinal axis of the flow stream.

3. The method according to claim 1, wherein the scattered light is detected by:
a first side scatter photodetector positioned at a 90° angle with respect to the incident beam of light irradiation; and
a second side scatter photodetector positioned at an angle that is less than 90° with respect to the incident beam of light irradiation.

4. The method according to claim 3, wherein the second side scatter photodetector is configured to detect back scattered light from the flow stream.

5. The method according to claim 4, wherein the back scattered light from the flow stream is propagated to the second side scattered photodetector with a mirror and a collection lens.

6. The method according to claim 5, wherein the mirror comprises a mirror with a hole.

7. The method according to claim 1, wherein the side scatter photodetectors are positioned at an angle of less than 90° with respect to the incident beam of light irradiation.

8. The method according to claim 1, wherein the method further comprises detecting scattered light with a forward scatter photodetector.

9. The method according to claim 1, wherein the method comprises:
generating a data signal from the scattered light with each of the photodetectors;
calculating a ratio of data signals from two or more of the photodetectors; and
determining the size of the particle based on the calculated ratio of the data signals.

10. The method according to claim 9, wherein the method comprises calculating a ratio of the data signals between each of the photodetectors.

11-13. (canceled)

14. The method according to claim 1, wherein the particle has a diameter of 200 nm or less.

15. (canceled)

16. The method according to claim 1, wherein the particles are cells.

17. The method according to claim 1, wherein the method comprises irradiating particles in a flow stream with a light source.

18-22. (canceled)

23. The method according to claim 1, wherein scattered light from the flow stream is propagated to the photodetectors with an optical collection component.

24-43. (canceled)

44. A system configured to determine a size of a particle in a flow stream from scattered light detected by two or more side scatter photodetectors.

45. The system according to claim 44, wherein the side scatter photodetectors are positioned parallel to the longitudinal axis of the flow stream.

46. The system according to claim 44, wherein the system comprises:
a first side scatter photodetector positioned at a 90° angle with respect to the incident beam of light irradiation; and
a second side scatter photodetector positioned at an angle that is less than 90° with respect to the incident beam of light irradiation.

47. The system according to claim 46, wherein the second side scatter photodetector is configured to detected back scattered light from the flow stream.

48. The system according to claim 47, wherein the system comprises a mirror configured to propagate back scattered light from the flow stream to the second side scattered photodetector.

49. The system according to claim 48, wherein the mirror comprises a hole.

50-98. (canceled)
